(19) United States
(12) Patent Application Publication
(10) Pub. No.: US 2026/0206081 A1
(43) Pub. Date: Jul. 16, 2026

(54) FILTERING FOR NETWORK SLICES

(71) Applicant: QUALCOMM Incorporated, San Diego, CA (US)

(72) Inventors: Juan ZHANG, San Diego, CA (US); Ajith Tom PAYYAPPILLY, San Diego, CA (US); Sitaramanjaneyulu KANAMARLAPUDI, San Diego, CA (US)

(21) Appl. No.: 19/016,675

(22) Filed: Jan. 10, 2025

(51) Int. Cl. H04W 76/15; H04L 45/745; H04W 48/18

(52) U.S. Cl. CPC H04W 76/15; H04L 45/745; H04W 48/18

(57) ABSTRACT

Various aspects of the present disclosure generally relate to wireless communication. In some aspects, a user equipment (UE) may send a first request to establish a first packet data unit (PDU) session that is associated with a first network slice. The UE may send a second request to establish a second PDU session that is associated with a second network slice. The UE may obtain a packet that indicates a first Internet protocol (IP) address associated with the first PDU session. The UE may send the packet with a second IP address that is associated with the second PDU session based at least in part on a match between one or more traffic parameters of the packet and one or more filters. Numerous other aspects are described.

### INTRODUCTION

Aspects of the present disclosure generally relate to wireless communication and specifically relate to techniques, apparatuses, and methods associated with protocol data unit (PDU) sessions and network slicing.

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a user equipment (UE). The apparatus may include one or more memories and one or more processors coupled to the one or more memories. The one or more processors may be configured to cause the UE to send a first request to establish a first packet data unit (PDU) session that is associated with a first network slice. The one or more processors may be configured to cause the UE to send a second request to establish a second PDU session that is associated with a second network slice. The one or more processors may be configured to cause the UE to obtain a packet that indicates a first Internet protocol (IP) address associated with the first PDU session. The one or more processors may be configured to cause the UE to send the packet with a second IP address that is associated with the second PDU session based at least in part on a match between one or more traffic parameters of the packet and one or more filters.

Some aspects described herein relate to a method of wireless communication performed at a UE. The method may include sending a first request to establish a first PDU session that is associated with a first network slice. The method may include sending a second request to establish a second PDU session that is associated with a second network slice. The method may include obtaining a packet that indicates a first IP address associated with the first PDU session. The method may include sending the packet with a second IP address that is associated with the second PDU session based at least in part on a match between one or more traffic parameters of the packet and one or more filters.

Some aspects described herein relate to a non-transitory computer-readable medium that stores a set of instructions for wireless communication by a UE. The set of instructions, when executed by one or more processors of the UE, may cause the UE to send a first request to establish a first PDU session that is associated with a first network slice. The set of instructions, when executed by one or more processors of the UE, may cause the UE to send a second request to establish a second PDU session that is associated with a second network slice. The set of instructions, when executed by one or more processors of the UE, may cause the UE to obtain a packet that indicates a first IP address associated with the first PDU session. The set of instructions, when executed by one or more processors of the UE, may cause the UE to send the packet with a second IP address that is associated with the second PDU session based at least in part on a match between one or more traffic parameters of the packet and one or more filters.

Some aspects described herein relate to an apparatus for wireless communication. The apparatus may include means for sending a first request to establish a first PDU session that is associated with a first network slice. The apparatus may include means for sending a second request to establish a second PDU session that is associated with a second network slice. The apparatus may include means for obtaining a packet that indicates a first IP address associated with the first PDU session. The apparatus may include means for sending the packet with a second IP address that is associated with the second PDU session based at least in part on a match between one or more traffic parameters of the packet and one or more filters.

Some aspects described herein relate to an apparatus for wireless communication at a network node. The apparatus may include one or more memories and one or more processors coupled to the one or more memories. The one or more processors may be configured to cause the network node to obtain a first request to establish a first PDU session that is associated with a first network slice. The one or more processors may be configured to cause the network node to obtain a second request to establish a second PDU session that is associated with a second network slice. The one or more processors may be configured to cause the network node to send, for the second PDU session, configuration information that indicates one or more first quality of service (QoS) parameters that are based at least in part on one or more traffic types to be communicated via the second PDU session.

Some aspects described herein relate to a method of wireless communication performed at a network node. The method may include obtaining a first request to establish a first PDU session that is associated with a first network slice. The method may include obtaining a second request to establish a second PDU session that is associated with a second network slice. The method may include sending, for the second PDU session, configuration information that indicates one or more first QoS parameters that are based at least in part on one or more traffic types to be communicated via the second PDU session.

Some aspects described herein relate to a non-transitory computer-readable medium that stores a set of instructions for wireless communication by a network node. The set of instructions, when executed by one or more processors of the network node, may cause the network node to obtain a first request to establish a first PDU session that is associated with a first network slice. The set of instructions, when executed by one or more processors of the network node, may cause the network node to obtain a second request to establish a second PDU session that is associated with a second network slice. The set of instructions, when executed by one or more processors of the network node, may cause the network node to send, for the second PDU session, configuration information that indicates one or more first QoS parameters that are based at least in part on one or more traffic types to be communicated via the second PDU session.

Some aspects described herein relate to an apparatus for wireless communication. The apparatus may include means for obtaining a first request to establish a first PDU session that is associated with a first network slice. The apparatus may include means for obtaining a second request to establish a second PDU session that is associated with a second network slice. The apparatus may include means for sending, for the second PDU session, configuration information that indicates one or more first QoS parameters that are based at least in part on one or more traffic types to be communicated via the second PDU session.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example architecture of a functional framework for radio access network intelligence enabled by data collection, in accordance with the present disclosure.

FIG. 4 is a diagram illustrating an example of network slice establishment, in accordance with the present disclosure.

FIGS. 5A-5C are diagrams of an example associated with filtering for network slices, in accordance with the present disclosure.

FIG. 6 is a diagram illustrating an example associated with filtering for network slices, in accordance with the present disclosure.

FIGS. 7A-7B are diagrams illustrating an example associated with filtering for network slices, in accordance with the present disclosure.

FIG. 8 is a diagram illustrating an example process performed, for example, at a UE or an apparatus of a user equipment (UE), in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a diagram illustrating an example of an implementation of code and circuitry for an apparatus, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

### DETAILED DESCRIPTION

In the context of wireless communication, a protocol data unit (PDU) session is a logical data session between a user equipment (UE) and a data network, such as the Internet or a private data network. A PDU session may serve as a dedicated logical channel for transmitting user plan data, such as Internet traffic, voice calls, multimedia traffic, and/or other data traffic, between the UE and the data network. A PDU session may be associated with a PDU type, such as an Internet protocol (IP) data (e.g., internet browsing) PDU type, or a non-IP data PDU type, among other examples. A PDU session may support different types of services, such as enhanced mobile broadband (eMBB), ultra-reliable low-latency communication (URLLC), and/or massive machine-type communication (mMTC), among other examples.

A UE may transmit a request to establish a PDU session. For example, the UE may transmit the request to a network node (e.g., which may forward the request to a core network node, such as an access and mobility management function (AMF) entity of the core network). The AMF entity may communicate with a session management function (SMF) entity of the core network to create, modify, and/or release a PDU session. After the PDU session is established, data associated with the UE may be communicated between the UE and the core network via a user plane function (UPF) entity.

In some examples, a PDU session may be associated with (e.g., may be configured with) one or more quality of service (QoS) flows. A QoS flow may define one or more QoS parameters. A QoS parameter may be an attribute that defines how communicated data should be treated. For example, a QoS parameter may include a priority level, a throughput parameter (e.g., to define a minimum and/or maximum data rate), a latency parameter (e.g., to define an acceptable delay or response time), a packet loss tolerance parameter (e.g., to define an acceptable packet loss rate), and/or a jitter tolerance parameter (e.g., to define an acceptable variation in delay), among other examples. A QoS flow may be mapped to one or more radio bearers of a wireless communication network. A radio bearer may be a logical channel between the UE and a radio access network (RAN). For example, a radio bearer may be associated with an air interface and may be mapped to physical radio resources.

A PDU session may enable a UE to communicate data over different network slices. As used herein, “network slice” refers to a virtualized or logical network that is allocated for a specific application, use case, users, traffic characteristic, or another granularity. For example, a network slice may be a logical network that provides specific network capabilities and/or network characteristics, supporting various service properties for network slice customers. In some examples, a network slice may be, or may include, a PDU session. In some examples, a UE and one or more network entities may establish a default network slice for communication between the UE and the one or more network entities. The default network slice may be “default” in that traffic that is not associated, or mapped to, another network slice or another PDU session is communicated via the default network slice. A network operator, such as a telecommunications provider, may configure network slicing for a wireless communication network (e.g., for one or more network slice customers). By providing network slicing, a network operator may deploy multiple substantially independent end-to-end networks potentially with the same infrastructure. In some examples, a network slice may be customized for different services (e.g., one or more non-default network slices may be defined for respective services). For example, the network operator may establish multiple network slices that are each associated with a common physical infrastructure (e.g., a UE may transmit data for the multiple network slices using the common physical infrastructure). As an example, a network node may allocate resources for a first network slice for an eMBB service, a second network slice for an URLLC service, a third network slice for public safety services, a fourth network slice for machine type communication services, a fifth network slice for device-to-device (e.g., vehicle-to-everything (V2X)) service), or a sixth network slice for general purpose services (e.g., services other than the aforementioned services), among other examples. Different network slices may be associated with different QoS parameters.

In some examples, a given traffic type may be communicated by the UE via a given network slice (e.g., a non-default network slice). For example, traffic for a given application may be communicated by the UE via a network slice associated with enhanced QoS parameters (e.g., for low latency, low packet loss, high reliability, and/or other enhanced QoS parameters). Different entities may perform coordination to ensure that traffic for a given application is communicated via the given network slice (e.g., with enhanced QoS parameters). For example, there may be agreements between an operating system vendor (e.g., of a high-level operating system (HLOS) of the UE), an application vendor (e.g., of the given application), and a network operator that the traffic for the given application should be communicated by the UE via the given network slice. For example, an interface may be made available by the network operator to enable an application server to request that the traffic for the given application (e.g., executing on the UE) should be communicated by the UE via the given network slice.

For example, after the application is launched on the UE, the application may send a request to an application server for traffic of the application to be communicated via the given network slice (e.g., to indicate to the application server that the application is executing on the UE). The application server may send, and a core network entity (e.g., an application function (AF) entity) may obtain, one or more QoS requirements for the application. The core network entity may determine policy information for the application based at least in part on the one or more QoS requirements. The core network entity may send, and the UE may receive, a policy update indicating an updated UE route selection policy (URSP) for the application. “URSP” refers to one or more rules or criteria used by a UE to determine and/or select a data route for communication. The updated URSP may indicate that traffic for the application is to be communicated via the given network slice (e.g., that is configured by the core network entity based at least in part on the one or more QoS requirements provided by the application server). The application (e.g., an application that is executing on the UE) may send, and the HLOS of the UE may obtain, a request for the traffic of the application to be communicated via the given network slice. The UE may send, and one or more network entities may receive, a request to establish a PDU session for the given network slice. The UE may communicate with the one or more network entities to establish the PDU session for the given network slice. After the UE establishes the PDU session, the application may send, and a processing system of the UE may obtain, data with an address (e.g., an IP address) for the PDU session for the given network slice. The UE may send, and one or more network entities may obtain, the traffic via the PDU session for the given network slice.

This results in the traffic for the application being communicated by the UE via the given network slice (e.g., that is established based at least in part on the one or more QoS requirements provided by the application server). However, this process is complex and involves coordination among multiple entities and/or vendors to establish the given network slice in addition to a default network slice. For example, the process to cause the traffic for the application (e.g., the application that is executing on the UE) being communicated by the UE via the given network slice includes multiple communications between the application, the HLOS of the UE, the application server, and one or more core network entities. For example, an application server may send, to a core network entity, QoS parameters or requirements for an application executing on the UE. The core network may configure a network slice in accordance with the QoS parameters or requirements (e.g., by updating a URSP for the UE). The UE may obtain, from the core network entity, a URSP policy update indicating the network slice and/or one or more filters that indicate (e.g., that are configured for detection) of traffic associated with the application that is executing on the UE. The UE and the core network entity may communicate to establish a PDU session for the network slice. The UE may route traffic to the network slice based on the one or more filters configured by the core network entity. The multiple communications consume network resources and/or processing resources, among other examples. Additionally, the multiple communications may increase latency associated with establishing the given network slice.

Various aspects relate generally to filtering for network slices. Some aspects relate to a UE using one or more filters to identify traffic that is to be communicated via a special network slice. “Special” network slice refers to a network slice associated with (e.g., configured for) one or more traffic types. In some aspects, the UE may send, and one or more network entities (e.g., a network node and/or one or more core network entities) may obtain, a request to establish a first PDU session for a packet data network (PDN). A PDN refers to a communication network that is associated with data transmission in the form of packets. “Packet” refers to a unit of data that includes a payload (e.g., data) and header information (e.g., for routing and delivery). In some examples, the first PDU session may be associated with a default network slice. The UE may obtain configuration information (e.g., an original equipment manufacturer configuration) that indicates that the UE is to establish a second network slice for the PDN (e.g., based on a network operator that is associated with a wireless communication network (e.g., a radio access network (RAN)) in which the UE is operating).

The UE may send, and the one or more network entities (e.g., a network node and/or one or more core network entities) may obtain, a request to establish a second PDU session for the PDN. In some aspects, the UE may autonomously send the request to establish the second PDU session after sending the request to establish the first PDU session based at least in part on a route selection policy of the UE. In this context, “autonomously” may refer to the UE sending the request to establish the second PDU session without obtaining instructions or commands (such as instructions or commands from a network node, application, or HLOS of the UE) to send the request to establish the second PDU session. Autonomously may refer to the UE sending the request automatically, independently, preemptively, without help, in an unassisted manner, in an unprompted manner, and/or by default, among other examples. The route selection policy may be a URSP that is stored by the UE. In some aspects, the configuration information that indicates that the UE is to establish the second network slice for the PDN includes the route selection policy.

A core network entity may obtain the request to establish the second PDU session. The core network entity may accept the request and determine PDU configuration information for the second PDU session. The configuration information for the second PDU session may include one or more QoS parameters for a special network slice. The core network entity may accept the request based at least in part on the URSP of the UE. The core network entity may accept the request independent of information received from an application server. For example, the core network entity may accept the request without obtaining information from the application server. For example, a network operator may configure the core network entity with the one or more QoS parameters for the special network slice. The core network entity may send, and a network node (e.g., a RAN node) may obtain, the PDU configuration information for the second PDU session.

The network node may establish a radio bearer for the second PDU session based at least in part on the one or more QoS parameters for the special network slice (e.g., indicated by the PDU configuration information for the second PDU session). For example, the network node may establish a first radio bearer for the first PDU session (e.g., a default network slice) and a second radio bearer for the second PDU session (e.g., the special network slice). The second radio bearer may be configured with the one or more QoS parameters for the special network slice.

The UE may obtain filter information indicative of a type of traffic to be communicated by the UE via the special network slice (e.g., via the second PDU session and/or the second radio bearer). For example, the filter information may indicate one or more uplink filters and/or one or more downlink filters, among other examples. The one or more uplink filters may be used by the UE to be used to identify uplink traffic to be communicated by the UE via the special network slice. The one or more downlink filters may be used by the UE to identify downlink traffic to be communicated by the UE via the special network slice. As used herein, “filter” refers to a condition or rule to be used to identify a data flow (e.g., an IP flow) to be to be used to identify traffic to be communicated by the UE via a special network slice. A filter may include a traffic flow template (TFT). For example, a filter may include a tuple that identifies a given traffic type. For example, the tuple include a source IP address, a destination IP address, a source port number (e.g., a port number of the source device sending the traffic), a destination port number (e.g., a port number of the source device obtaining the traffic), and a protocol (e.g., a transport layer protocol being used). As used herein, “source IP address” refers to an address of a component from which a packet originated. As used herein, “destination IP address” refers to an address of a component that is to receive a packet. As used herein, “traffic type” refers to a classification or category of traffic that is associated with a given activity or service. For example, a traffic type may include Internet browsing, gaming, streaming, voice over IP (VoIP), and/or peer-to-peer, among other examples. By the UE using one or more filters to identify one or more packets to be communicated via the special network slice, the UE may communicate via the special network slice without an HLOS of the UE and/or one or more applications executing on the UE being aware of the special network slice. This reduces the complexity and signaling overhead associated with establishing the special network slice.

In some aspects, the UE may obtain the filter information using one or more artificial intelligence (AI) and/or machine learning (ML) (AI/ML) techniques. For example, the UE may provide, and an AI/ML model may obtain, an input that indicates one or more traffic types and historical traffic communicated by the UE. The one or more traffic types may be one or more traffic types to be communicated via the special network slice. The AI/ML model may be configured to output one or more filters that enable the UE to identify traffic belonging to the one or more traffic types. For example, the AI/ML model may output, and the UE may obtain, the filter information for the special network slice. By the UE obtaining the filter information via the AI/ML model, an accuracy of the filter information may be improved because the AI/ML model may be configured to determine filter information based on the historical traffic, thereby enabling the AI/ML model to infer or predict one or more filters that can be used to identify one or more traffic types that may be rarely seen (or have not been seen) by the UE. In some other aspects, an HLOS of the UE may send, and the UE (e.g., a processing system of the UE) may obtain, the filter information for the special network slice. In some aspects, the filter information may be based at least in part on the one or more traffic types. For example, the filter information may indicate the one or more filters that indicate the one or more traffic types. In some aspects, a network node may send, and the UE may obtain, the one or more traffic types.

An application (e.g., an application executing on the UE) and/or an HLOS of the UE may send, and a processing system of the UE may obtain, a packet (e.g., data) to be sent by the UE. The packet may be associated with the first PDU session and/or the default network slice. In some aspects, the application and/or the HLOS may be unaware that the special network slice is available and/or has been established. The UE may compare one or more traffic parameters of the packet to the one or more filters (e.g., one or more uplink filters). As used herein, “traffic parameter” refers to a parameter used to distinguish or identify a flow, such as an IP flow or a network flow. A traffic parameter may be indicated in a header of a packet. For example, a traffic parameter may include a TFT, a source IP address, a destination IP address, a source port number, a destination port number, and/or a protocol. If the one or more traffic parameters match the one or more filters, then the UE may determine that the packet is to be sent by the UE via the special network slice. As used herein, one or more traffic parameters may “match” a filter if the filter and the one or more traffic parameters include the same values (such as for a TFT, a source IP address, a destination IP address, a source port number, a destination port number, and/or a protocol). If the one or more traffic parameters match the one or more filters, then the UE may modify (e.g., may translate) an address of the packet from a first address (e.g., associated with the first PDU session) to a second address (e.g., associated with the second PDU session). The address may be an IP address, such as a source IP address. The UE may send, and a network node may obtain, the packet (e.g., with the second address) via the second PDU session, the second network slice, and/or the second radio bearer. As a result, the packet may be treated by the network node in accordance with the QoS parameter(s) for the special network slice. This improves communication performance for the packet by enabling the data to be communicated via the special network slice because the special network slice may be configured with one or more QoS parameters designed for a traffic type associated with the packet.

In some aspects, the network node may send, and the UE may obtain, a packet (e.g., downlink data) via the second PDU session, the second network slice, and/or the second radio bearer. The UE may compare one or more traffic parameters of the packet to the one or more filters (e.g., one or more downlink filters). If the one or more traffic parameters match the one or more downlink filters, then the UE may determine that the packet is to be sent by the UE to the HLOS of the UE and/or the application executing on the UE with an address identifying the first PDU session (e.g., because the HLOS and/or the application may be unaware of the second PDU session). If the one or more traffic parameters match the one or more downlink filters, then the UE may modify (e.g., may translate) the address of the packet from a first address (e.g., associated with the second PDU session) to a second address (e.g., associated with the first PDU session). In such examples, the address may be a destination IP address. The UE may send, and the HLOS of the UE and/or the application executing on the UE may obtain, the packet with the second address (e.g., of the first PDU session).

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

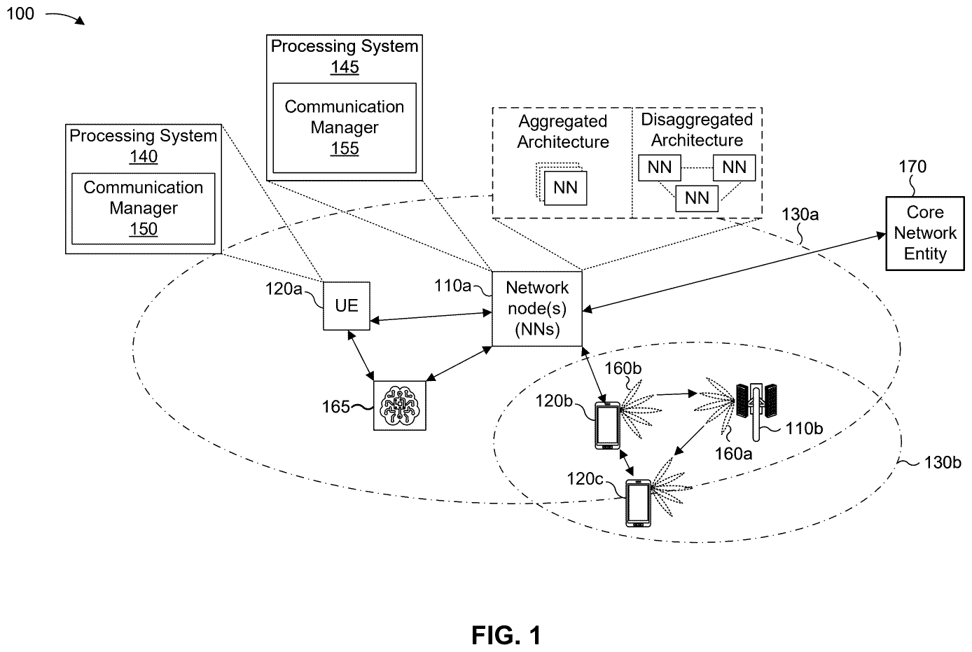

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR 4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

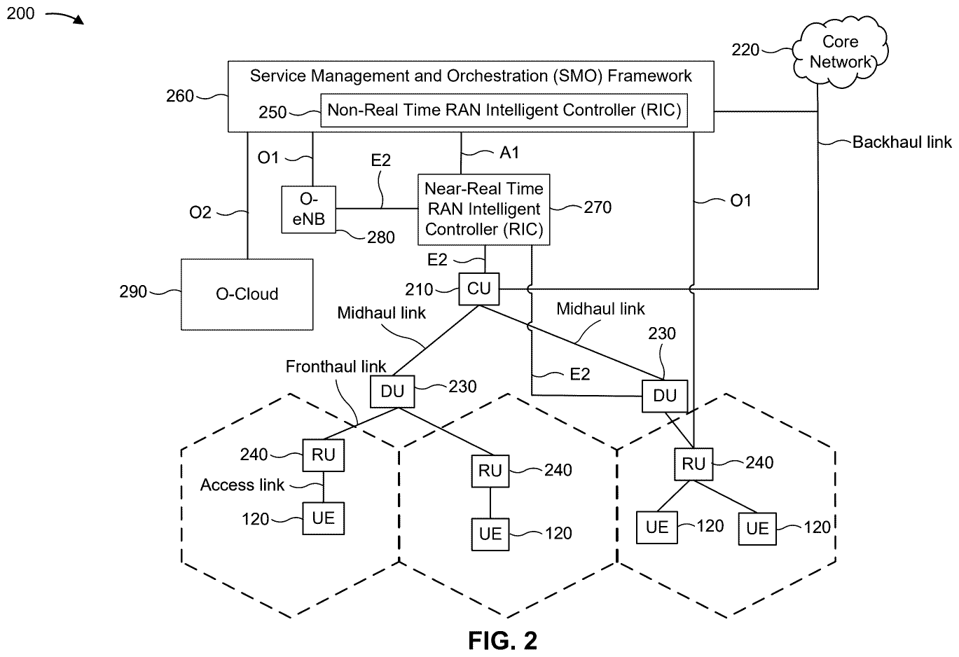

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some example, one or more devices in the wireless communication network 100 may communicate with a core network entity 170. For example, a core network may include one or more core network entities 170. For example, the core network may be a 5G core (5GC) or a 6G core. A core network entity 170 may include, for example, a mobility management entity (MME), an access and mobility management function (AMF), a gateway, a user plane function (UPF), or another core network entity. A core network entity 170, or a group of core network entities 170, may include a user plane entity that performs user plane related functions, such as packet transfer and IP address allocation. Additionally, or alternatively, a core network entity 170 or a group of core network entities 170 may include a control plane entity that manages functions, such as access, mobility, security, and/or bearer management. In some examples, one or more network nodes 110 may also perform functions. The core network may be associated with a divergent architecture. In some other examples, a service may perform or be configured to perform, for a given function, one or more operations performed by a core network entity 170 of a core network and/or one or more operations performed by a network node 110 of a wireless communication network 100 that incorporates a core network 100 (e.g., in a service-based architecture). For example, a service may be implemented on a physical device or as a cloud implementation (such as a virtual machine or a virtualized network function). In some examples, a service may perform one or more functions described herein as being performed by a core network entity, such as the core network entity 170.

In some examples, a UE 120 may send data to the core network entity 170 via a PDU session associated with a network slice. The network slice may be associated with one or more QoS parameters. In some examples, a network slice may be configured for one or more applications and/or one or more traffic types.

In some aspects, the UE 120 may include a communication manager 150. As described in more detail elsewhere herein, the communication manager 150 may send a first request to establish a first PDU session that is associated with a first network slice; send a second request to establish a second PDU session that is associated with a second network slice; obtain a packet that indicates a first IP address associated with the first PDU session; and send the packet with a second IP address that is associated with the second PDU session based at least in part on a match between one or more traffic parameters of the packet and one or more filters. Additionally, or alternatively, the communication manager 150 may perform one or more other operations described herein.

In some aspects, the network node 110 may include a communication manager 155. As described in more detail elsewhere herein, the communication manager 155 may obtain a first request to establish a first PDU session that is associated with a first network slice; obtain a second request to establish a second PDU session that is associated with a second network slice; and send, for the second PDU session, configuration information that indicates one or more first QoS parameters that are based at least in part on one or more traffic types to be communicated via the second PDU session. Additionally, or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

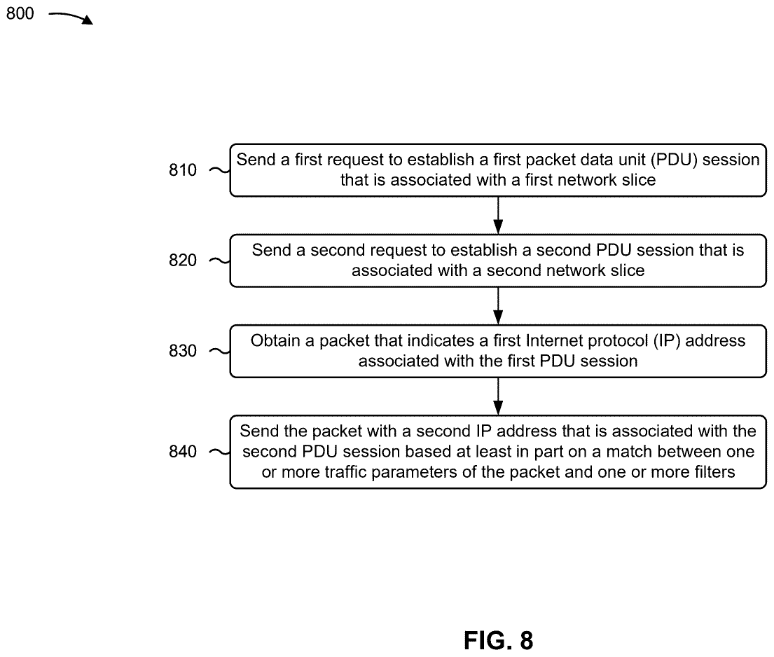

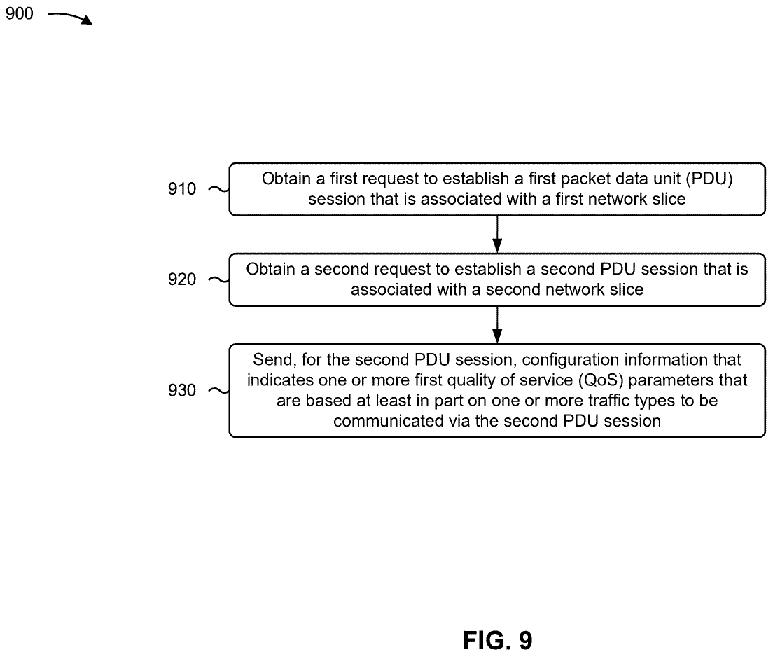

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with filtering for network slices, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for sending a first request to establish a first PDU session that is associated with a first network slice; means for sending a second request to establish a second PDU session that is associated with a second network slice; means for obtaining a packet that indicates a first IP address associated with the first PDU session; and/or means for sending the packet with a second IP address that is associated with the second PDU session based at least in part on a match between one or more traffic parameters of the packet and one or more filters.

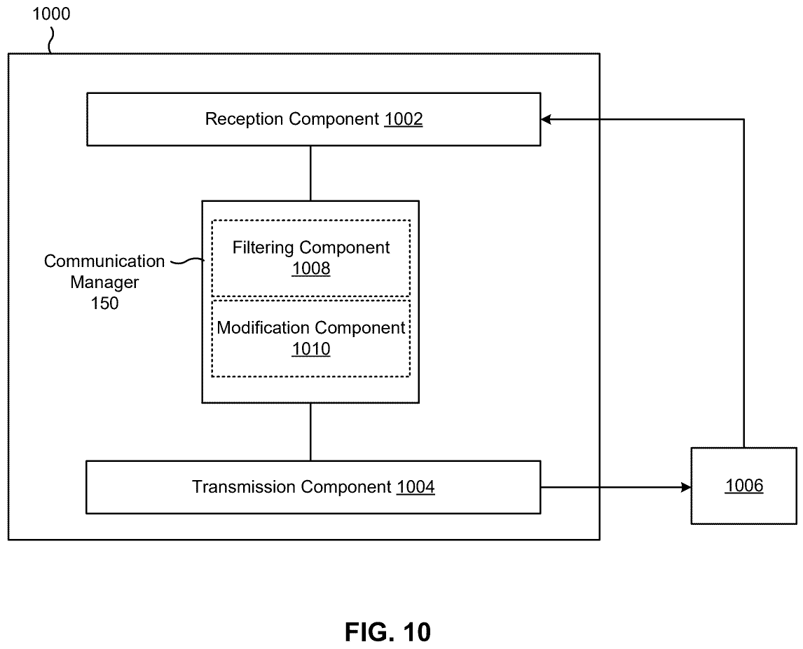

The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

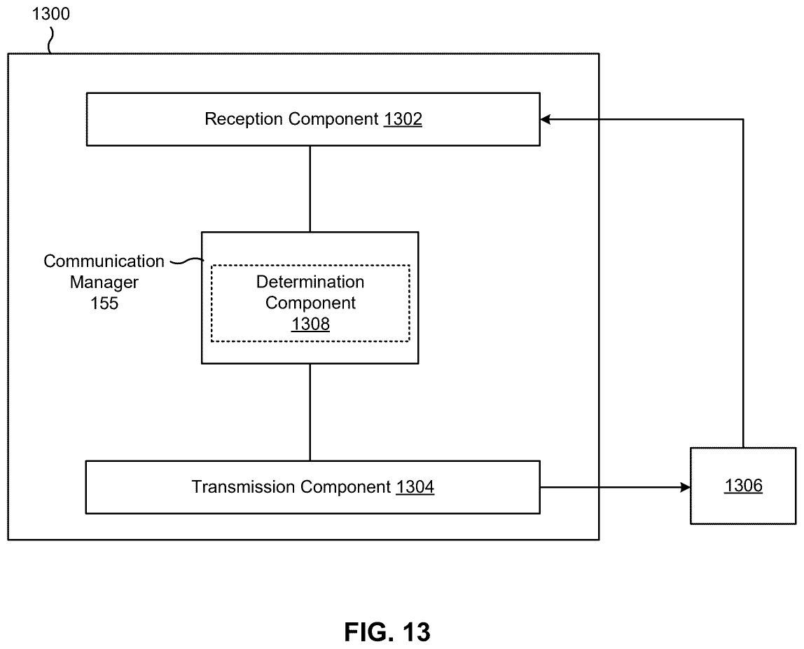

In some aspects, the network node 110 includes means for obtaining a first request to establish a first PDU session that is associated with a first network slice; means for obtaining a second request to establish a second PDU session that is associated with a second network slice; and/or means for sending, for the second PDU session, configuration information that indicates one or more first QoS parameters that are based at least in part on one or more traffic types to be communicated via the second PDU session. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

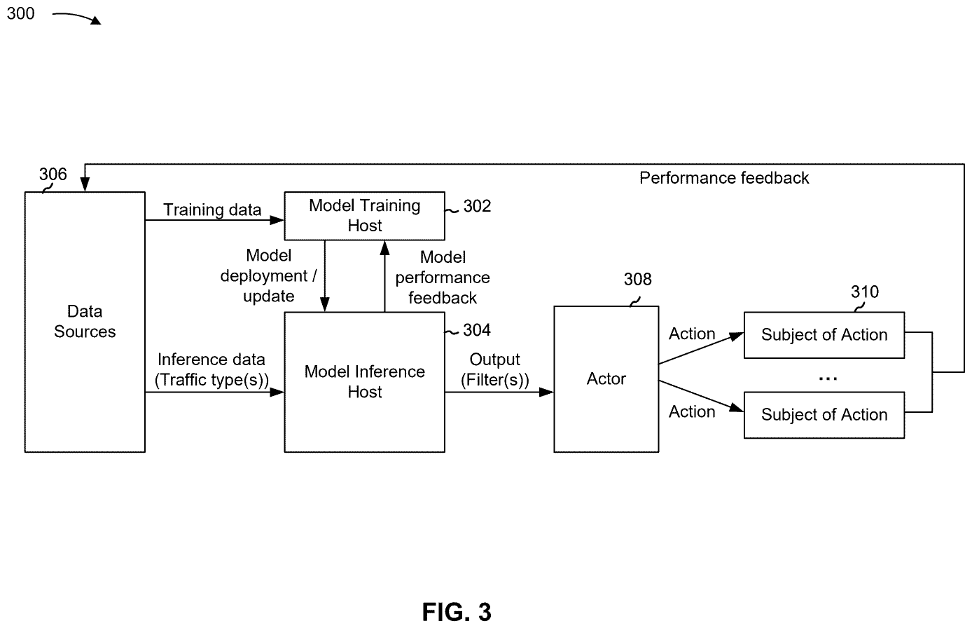

FIG. 3 is a diagram illustrating an example architecture 300 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 300, a functional framework for RAN intelligence may include multiple logical entities, such as a model training host 302, a model inference host 304, data sources 306, and an actor 308.

The model inference host 304 may be configured to run an AI/ML model based on inference data provided by the data sources 306, and the model inference host 304 may produce an output (e.g., a prediction) with the inference data input to the actor 308. The inference data may include one or more traffic types to be communicated via a special network slice. Additionally, or alternatively, the inference data may include historical data (e.g., previously communicated data). The actor 308 may be an element or an entity of a core network or a RAN. For example, the actor 308 may be a UE, a network node, base station (e.g., a gNB), a CU, a DU, and/or an RU, among other examples. In addition, the actor 308 may also depend on the type of tasks performed by the model inference host 304, type of inference data provided to the model inference host 304, and/or type of output produced by the model inference host 304. For example, if the output from the model inference host 304 is associated with position determination, the actor 308 may be a UE, a DU or an RU. In some examples, the model inference host 304 may be hosted on the actor 308. For example, a UE may be the actor 308 and may host the model inference host 304. In some aspects, a UE (e.g., the actor 308) may be a data source 306. For example, the UE may perform a measurement (e.g., an NR measurement), may input the measurement to the AI/ML model at the model inference host 304 (or may provide the measurement to the model inference host 304), and may act based on an output of the AI/ML model. The output of the AI/ML model may include filter information to be used to identify a packet that is associated with a given traffic type.

After the actor 308 receives an output from the model inference host 304, the actor 308 may determine whether to act based on the output. For example, if the actor 308 is a UE and the output from the model inference host 304 is associated with filter information, the actor 308 may determine whether a packet is associated with a given traffic type based on one or more filters indicated by the filter information, among other examples. As another example, the actor 308 may determine whether a packet is to be communicated via a special network slice based on one or more filters indicated by the filter information. If the actor 308 determines to act based on the output, in some examples, the actor 308 may indicate the action to at least one subject of action 310.

The data sources 306 may also be configured for collecting data that is used as training data for training an ML model or as inference data for feeding an ML model inference operation. For example, the data sources 306 may collect data from one or more core network and/or RAN entities, which may include the actor 308 or the subject of action 310, and provide the collected data to the model training host 302 for ML model training. In some aspects, the model training host 302 may be co-located with the model inference host 304 and/or the actor 308. For example, the actor 308 or the subject of action 310 may provide performance feedback associated with the beam configuration to the data sources 306, where the performance feedback may be used by the model training host 302 for monitoring or evaluating the ML model performance, such as whether the output (e.g., prediction) provided to the actor 308 is accurate. In some examples, the model training host 302 may monitor or evaluate ML model performance using a training position value, which may be provided by a node (e.g., a UE 120 or a network node 110), as described elsewhere herein. In some examples, if the output provided by the actor 308 is inaccurate (or the accuracy is below an accuracy threshold), then the model training host 302 may determine to modify or retrain the ML model used by the model inference host, such as via an ML model deployment/update.

As indicated above, FIG. 3 is provided as an example. Other examples may differ from what is described with regard to FIG. 3.

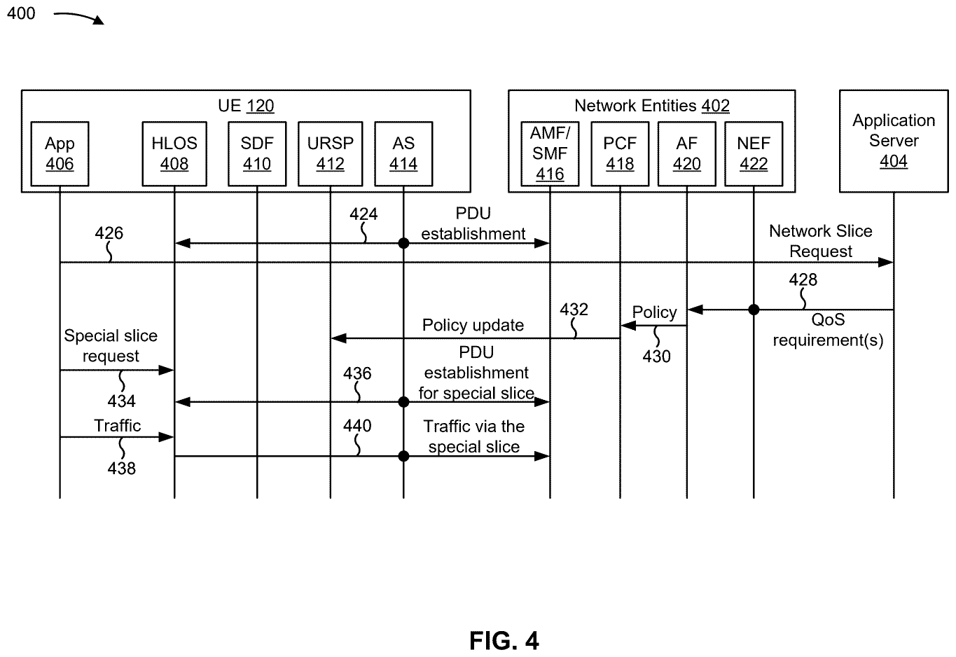

FIG. 4 is a diagram illustrating an example 400 of network slice establishment, in accordance with the present disclosure. As shown in FIG. 4, a UE 120, one or more network entities 402, and an application server 404 may communicate with each other. The example 400 may be an example of a network slice (e.g., a special network slice) established based at least in part on a request by the application server 404. The application server 404 may be configured to support and/or manage an application 406 executing on the UE 120.

The UE 120 may include an HLOS 408. The HLOS 408 may be configured to manage one or more higher-layer functions of the UE, such as application layer management, network protocol handling, and/or session management, among other examples. The HLOS 408 may interface with one or more components of a processing system of the UE 120, such as the processing system 140, for lower-layer protocols. The UE 120 may include a service data flow (SDF) component 410, a URSP component 412, and an access stratum (AS) component 414. The SDF component 410 may be a logical representation of a data flow associated with a particular service or application (e.g., the application 406) of the UE 120. The URSP component 412 may store one or more URSPs of the UE 120. The AS component 414 may manage RAN communication, such as all interactions between the UE 120 and a RAN, such as the wireless communication network 100.

The one or more network entities 402 may include one or more network nodes 110 (e.g., one or more RAN nodes) and/or one or more core network entities 170. For example, the one or more network entities 402 may include an AMF/SMF 416, a policy control function (PCF) 418, an application function (AF) 420, and a network exposure function (NEF) 422, among other examples. The AF 420 may include one or more devices that support application influence on traffic routing, access to the NEF 422, and/or policy control, among other examples. The AMF may include one or more devices that act as a termination point for non-access stratum (NAS) signaling and/or mobility management, among other examples. The SMF may include one or more devices that support the establishment, modification, and release of communication sessions in the wireless communication network. For example, the SMF may configure traffic steering policies at a user plane function (UPF) and/or enforce UE IP address allocation and policies, among other examples. In some aspects, the SMF may provision the network slice instances for the UE 120. The PCF 418 may include one or more devices that provide a policy framework that incorporates network slicing, roaming, packet processing, and/or mobility management, among other examples. In some aspects, the PCF 418 may include one or more URSP rules to select network slice instances for the UE 120.

As shown in FIG. 4, and by reference number 424, the UE 120 and the one or more network entities 402 may communicate for PDU establishment of a first PDU session. For example, the HLOS 408 of the UE 120 and the AMF/SMF 416 of the one or more network entities 402 may communicate to establish the first PDU session. The first PDU session may be a default PDU session associated with a first (e.g., default) network slice. For example, the default network slice may be associated with a route selection description (RSD) to a data network name (DNN) field included in a traffic descriptor of a PDN packet. For example, the default PDU session may be a default PDU session for Internet traffic communicated by the UE 120.

As shown by reference number 426, the application 406 may send, and the application server 404 may obtain, a network slice request. The network slice request may be a request from the application 406 for treatment associated with a second (e.g., a special) network slice by the one or more network entities 402. As shown by reference number 428, the application server 404 may send, and the AF 420 (e.g., via the NEF 422) may obtain, one or more QoS requirements for the application 406. The one or more QoS requirements may include requested values for respective QoS parameters. As shown by reference number 430, the AF 420 may send, and the PCF 418 may obtain, a policy for the application 406. The policy may be a URSP that is based at least in part on the one or more QoS requirements. For example, the URSP may indicate that traffic for the application 406 is to be routed to a network slice (e.g., a special network slice or non-default network slice) that is associated with one or more QoS parameters that are based at least in part on the one or more QoS requirements.

As shown by reference number 432, the PCF 418 may send, and the UE 120 (e.g., the URSP component 412) may obtain, a policy update. The policy update may indicate the URSP for the application 406 (e.g., indicating that traffic for the application 406 is to be routed to the special network slice). As shown by reference number 434, the application 406 may send, and the HLOS 408 may obtain, a special slice request that indicates that the application 406 is requesting that traffic for the application 406 be routed to the special network slice.

Because the UE 120 has not yet established the special network slice with the one or more network entities 402, the UE 120 and the one or more network entities 402 may communicate for PDU establishment of a second PDU session associated with the special network slice, as shown by reference number 436. For example, the HLOS 408 of the UE 120 and the AMF/SMF 416 of the one or more network entities 402 may communicate to establish the second PDU session. The second PDU session may be a default PDU session associated with a second (e.g., special) network slice. As shown by reference number 438, the application 406 may send, and the HLOS 408 may obtain, traffic. The traffic may include information indicating that the traffic is to be communicated via the second PDU session and/or the special network slice. For example, the information may include a source IP address that is associated with the second PDU session. As shown by reference number 440, the UE 120 may send, and the one or more network entities 402 may obtain, the traffic via the special network slice (e.g., via the second PDU session).

This results in the traffic for the application 406 being communicated by the UE 120 via the special network slice (e.g., that is established based at least in part on the one or more QoS requirements provided by the application server 404). However, this process is complex and involves coordination among multiple entities and/or vendors. For example, the process to cause the traffic for the application 406 being communicated by the UE 120 via the special network slice includes multiple communications between the application 406, the HLOS 408, the application server 404, and the one or more network entities 402. The multiple communications consume network resources and/or processing resources, among other examples. Additionally, the multiple communications may increase latency associated with establishing the special network slice.

As indicated above, FIG. 4 is provided as an example. Other examples may differ from what is described with regard to FIG. 4.

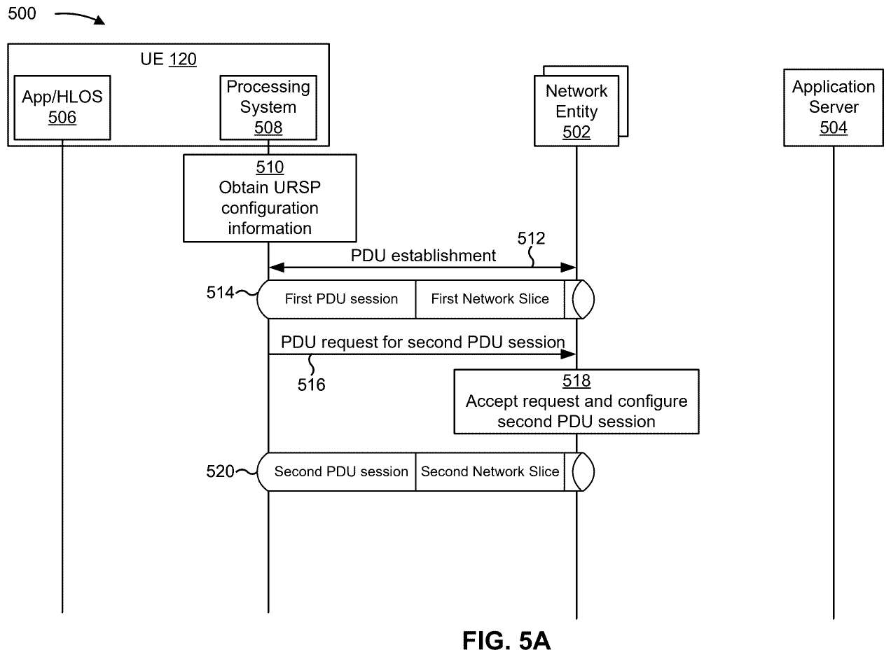

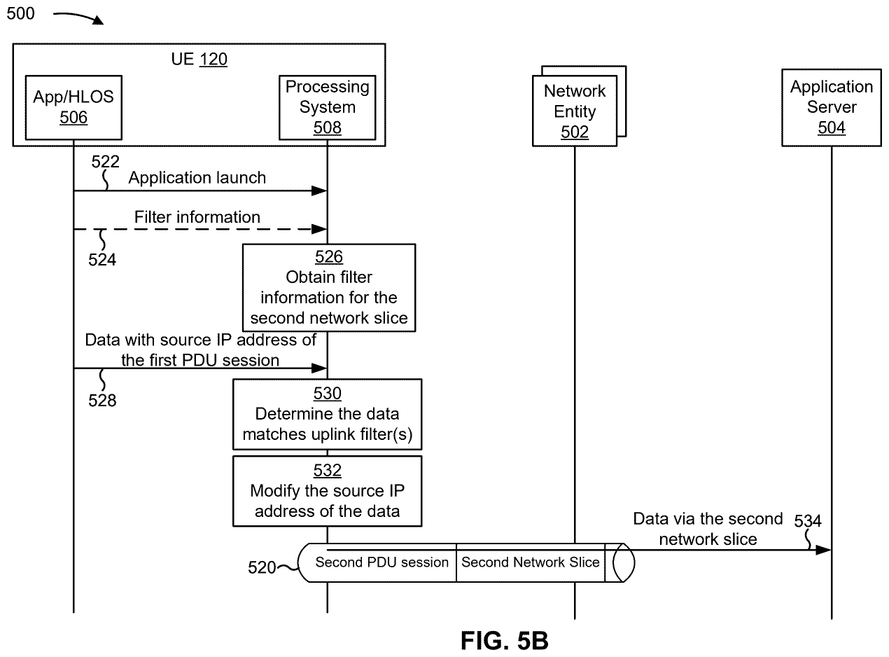

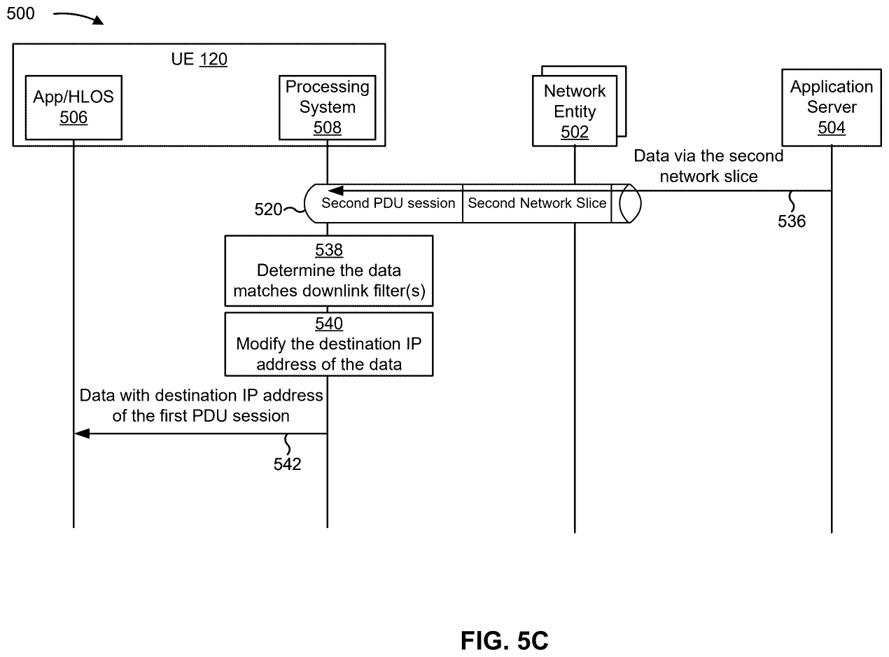

FIGS. 5A-5C are diagrams of an example 500 associated with filtering for network slices, in accordance with the present disclosure. As shown in FIGS. 5A-5C, one or more network entities 502 (e.g., a core network entity 170, a network node 110, a CU, a DU, and/or an RU) may communicate with a UE 120. In some aspects, the network entities 502 and the UE 120 may be part of a wireless network (e.g., wireless communication network 100). The UE 120 and one or more network entities 502 may have established a wireless connection prior to operations shown in FIGS. 5A-5C.

The UE 120 and the one or more network entities 502 may communicate with an application server 504. The application server 504 may be configured to manage and/or support an application executing on the UE 120. The UE 120 may include the application and/or HLOS (App/HLOS 506). The UE 120 may include a processing system 508. The processing system 508 may be, or may be similar to, the processing system 140. In some aspects, the processing system 508 may include a modem.

In some aspects, actions described herein as being performed by a network entity 502 may be performed by multiple different network nodes or entities. For example, configuration actions may be performed by a first network entity (for example, a core network entity, a CU, or a DU), and radio communication actions may be performed by a second network entity (for example, a DU or an RU).

As used herein, a network entity 502 “outputting,” “sending,” or “transmitting” a communication to the UE 120 may refer to a direct transmission (for example, from the network entity 502 to the UE 120) or an indirect transmission via one or more other network nodes or devices. For example, if the network entity 502 is a DU, an indirect transmission to the UE 120 may include the DU outputting, sending, or transmitting a communication to an RU and the RU transmitting the communication to the UE 120, or may include causing the RU to transmit the communication (e.g., triggering transmission of a physical layer reference signal). Similarly, the UE 120 “transmitting” or “sending” a communication to the network entity 502 may refer to a direct transmission (for example, from the UE 120 to the network entity 502) or an indirect transmission via one or more other network nodes or devices. For example, if the network entity 502 is a DU, an indirect transmission to the network entity 502 may include the UE 120 transmitting or sending a communication to an RU and the RU transmitting or sending the communication to the DU. Similarly, the network entity 502 “obtaining” or “receiving” a communication may refer to receiving a transmission carrying the communication directly (for example, from the UE 120 to the n network entity 502) or receiving the communication (or information derived from reception of the communication) via one or more other network nodes or devices.

In some aspects, the UE 120 may transmit or send capability information. The capability information may be included in a capability report. The UE 120 may transmit or send the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), and/or a physical sidelink shared channel (PSSCH), among other examples. The capability information may indicate one or more parameters associated with respective capabilities of the UE. The one or more parameters may be indicated via respective information elements (IEs) included in a capability report.

The capability information may indicate whether the UE 120 supports a feature and/or one or more parameters related to the feature. For example, the capability information may indicate a capability and/or parameter for supporting network slices. As another example, the capability information may indicate a capability and/or parameter for supporting filtering-based network slicing, as described in more detail elsewhere herein. For example, the capability information may indicate that the UE 120 supports installing one or more filters to identify traffic (e.g., data and/or packets) to be communicated via a special network slice. One or more operations described herein may be based on capability information. For example, the UE 120 may perform a communication in accordance with the capability information, or may receive configuration information that is in accordance with the capability information. In some aspects, the UE 120 may request a second PDU session for the special network slice after requesting a first PDU session for a default network slice based at least in part on the capability information.

In some aspects, a network entity 502 (e.g., a network node 110) may transmit or send, and the UE may receive or obtain, configuration information. In some aspects, the UE 120 may receive or obtain the configuration information via one or more of system information (e.g., a master information block (MIB) and/or a system information block (SIB), among other examples), radio resource control (RRC) signaling, one or more MAC control elements (MAC-CEs), and/or DC), among other examples.

In some examples, the configuration information may not be expressly signaled to the UE 120. For example, in some aspects, the configuration information may at least partially be defined by a wireless communication standard, such as the 3GPP. In such examples, the network entity 502 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may indicate that the UE 120 is to perform filtering-based network slicing, as described in more detail elsewhere herein. For example, the configuration information may indicate that the UE 120 is to request a second PDU session for the special network slice after requesting a first PDU session for a default network slice. In some aspects, the configuration information may include URSP information that indicates that the UE 120 is to support multiple network slices for Internet PDU sessions.

The UE 120 may configure itself based at least in part on the configuration information. In some aspects, the UE 120 may be configured to perform one or more operations described herein based at least in part on the configuration information.

As shown in FIG. 5A, and by reference number 510, the processing system 508 may obtain URSP configuration information. In some aspects, the URSP configuration information may be included in the configuration information described above. In some other aspects, the UE 120 may store the URSP configuration information, such as part of an OEM configuration. The URSP configuration information may include a route selection policy that indicates that the UE 120 supports multiple network slices for a data network, such as the Internet. In some aspects, the URSP configuration information may indicate a network operator. For example, if the wireless communication network in which the UE 120 is operating is associated with the network operator, then the UE 120 may apply the URSP configuration information. For example, the network operator may configure or provide the multiple network slices, as described in more detail elsewhere herein.

The multiple network slices may include a default network slice and one or more special network slices. The special network slice(s) may be associated with respective traffic types. For example, a first special network slice may be associated with gaming traffic (e.g., in which the first special network slice may be configured with a low-latency QoS parameter). A second special network slice may be associated with streaming traffic (e.g., in which the second special network slice is configured with a low-packet-loss QoS parameter and/or a low-jitter QoS parameter). The default network slice may be “default” in that traffic that is not associated with a traffic type that is mapped to a special network slice is communicated via the default network slice.

In some aspects, the URSP configuration information may indicate the one or more traffic types associated with special network slices. Additionally, or alternatively, a network entity 502 may transmit or send, and the UE 120 may receive or obtain, an indication of the one or more traffic types associated with special network slices.

As shown by reference number 512, the UE 120 (e.g., the processing system 508) and one or more network entities 502 may communicate to establish a first PDU session 514. For example, the UE 120 may transmit or send, and a network entity 502 may receive or obtain, a first PDU session establishment request. The first PDU session establishment request may include a purpose or type of the first PDU session 514, such as Internet, VoIP, video streaming, and/or another type of service. In some aspects, the first PDU session establishment request may indicate that the first PDU session 514 is being established for a first network slice (e.g., a default network slice).

In some aspects, the network entity 502 that obtains the first PDU session establishment request may be a network node 110. The network node 110 may send, and an AMF may obtain, the first PDU session establishment request. The AMF may determine whether the UE 120 is authorized for the PDU session, may handle initial mobility context, and may prepare the request for further processing by an SMF. The AMF may send, and the SMF may obtain, the PDU session establishment request. The SMF may determine how to handle the PDU session based at least in part on the type of service requested and one or more network policies. The SMF may allocate one or more bearers for the PDU session. The SMF may indicate one or more QoS parameters for each bearer of the PDU session. The SMF may determine how data should be routed within the network, including interaction with a UPF, which is responsible for handling user data traffic.

The SMF may send, and the network node 110 may obtain, a bearer context setup request indicating information for the one or more bearers, one or more QoS parameters, and/or other information for the first PDU session 514. The network node 110 may update a context with the information for the one or more bearers. The network node 110 may transmit or send, and the UE 120 may receive or obtain, configuration information for the first PDU session 514. The configuration information may be included in a PDU session establishment accept message for the first PDU session 514. The PDU session establishment accept message may indicate that the network has accepted the PDU session and indicate the information for the one or more bearers, one or more QoS parameters, and/or other information for the first PDU session 514. In some aspects, the UE 120 may transmit or send, and the network node 110 may receive or obtain, a PDU session establishment accept message indicating that the UE 120 is ready for communication via the first PDU session 514. The network node 110 may send, and the AMF may obtain, the PDU session establishment accept message. The SMF may send, and the network node 110 may obtain, a PDU session resource command to finalize the configuration of the first PDU session 514 and ensure that a data path is correctly established between the UE 120 and a UPF. The network node 110 may apply the bearer resource(s) and/or QoS parameters for respective bearers of the first PDU session 514.

The first PDU session 514 may be associated with a first network slice. For example, the one or more bearers may be configured for the first network slice. The first PDU session 514 may be a default PDU session for the type or service requested by the UE 120, such as Internet traffic. The first network slice may be a default network slice.

As shown by reference number 516, the UE 120 (e.g., the processing system 508) and one or more network entities 502 may communicate to establish a second PDU session 520. For example, the UE 120 may transmit or send, and a network entity 502 may receive or obtain, a second PDU session establishment request. In some aspects, the UE 120 may autonomously transmit the second PDU session establishment request after transmitting the first PDU session establishment request. For example, the UE 120 may determine that multiple PDU sessions and/or multiple network slices are to be established based at least in part on the URSP configuration information. The UE 120 may transmit or send the second PDU session establishment request based at least in part on the URSP configuration information (e.g., based at least in part on the URSP configuration information indicating that the multiple PDU sessions and/or multiple network slices are to be established).

The second PDU session establishment request may include a purpose or type of the second PDU session 520, such as Internet, VoIP, video streaming, and/or another type of service. In some aspects, the first PDU session 514 and the second PDU session 520 may be associated with the same purpose or type (e.g., Internet). In some aspects, the second PDU session establishment request may indicate that the second PDU session 520 is being established for a second network slice (e.g., a special network slice).

As shown by reference number 518, the one or more network entities 502 may accept the second PDU session establishment request. For example, an AMF and/or SMF may accept the second PDU session establishment request based at least in part on the URSP configuration information for the UE 120 (e.g., based at least in part on the URSP configuration information indicating that the multiple PDU sessions and/or multiple network slices are to be established). The one or more network entities 502 may accept the second PDU session establishment request independent of information from the application server 504. For example, the one or more network entities 502 may accept the second PDU session establishment request without receiving instructions or information from one or more application servers, such as the application server 504. The one or more network entities 502 and the UE 120 may establish the second PDU session 520 in a similar manner as described above in connection with the first PDU session 514.

As shown in FIG. 5B, an application may launch on the UE 120. In some aspects, as shown by reference number 522, the App/HLOS 506 may send, and the processing system 508 may obtain, an indication that the application has launched on the UE 120. In some aspects, as shown by reference number 524, the App/HLOS 506 may send, and the processing system 508 may obtain, filter information for the second network slice associated with the second PDU session 520. The filter information may include one or more filters to be used to identify traffic (e.g., data and/or packets) that is associated with a traffic type to be communicated by the UE 120 via the second network slice. For example, an HLOS of the UE 120 may send, and the processing system 508 may obtain, information about one or more applications executing on the UE 120. The information may include one or more traffic parameters of respective applications. Additionally, the information may indicate traffic types associated with the respective applications.

In some aspects, as shown by reference number 526, the UE 120 (e.g., the processing system 508) may obtain filter information for the second network slice. The filter information may include one or more filters. The one or more filters may include one or more traffic flow template filters. In some aspects, the one or more filters may indicate the one or more traffic types to be communicated by the UE 120 via the second PDU session 520 and/or the second network slice. For example, a filter may indicate or include one or more traffic parameters that are indicative of a traffic type. In some examples, the one or more filters are configured for detection or identification of the one or more traffic types to be communicated by the UE 120 via the second PDU session 520 and/or the second network slice. In some aspects, the one or more filters may include one or more uplink filters (e.g., configured for detection or identification of uplink data associated with the one or more traffic types) and/or one or more downlink traffic types (e.g., configured for detection or identification of downlink data associated with the one or more traffic types). In some aspects, the UE 120 may determine the filter information (e.g., based at least in part on the filter information obtained from the App/HLOS 506).

Additionally, or alternatively, the UE 120 may obtain the filter information using one or more machine learning techniques. For example, the UE 120 (e.g., the processing system 508) may send a machine learning input that includes traffic flow information for previously communicated traffic. In some aspects, the machine learning input may indicate the one or more traffic types to be communicated by the UE 120 via the second PDU session 520 and/or the second network slice. The machine learning input may be, or may be similar to, the input to the machine inference host 304 described in connection with FIG. 3. The UE 120 (e.g., the processing system 508) may obtain a machine learning output that indicates the filter information (e.g., that indicates the one or more filters). The machine learning output may indicate one or more IP flows. “IP flow” may refer to information (such as a 5-tuple) indicating a data flow. For example, the IP flow may indicate a source IP address, a source port, a destination IP address, a destination port, and a transport protocol. The machine learning output may be similar to the output from the machine inference host 304 described in connection with FIG. 3.

The UE 120 (e.g., the processing system 508) may install the one or more filters. For example, the UE 120 may configure the processing system 508 with the one or more filters on a data plane of the processing system 508. For example, the UE 120 may configure a UPF component of the processing system 508 with the one or more filters. The UE 120 may configure one or more uplink filters and/or one or more downlink filters on the data plane of the processing system 508.

As shown by reference number 528, the App/HLOS 506 may send, and the processing system 508 may obtain, data (e.g., one or more packets). The one or more packets may be associated with one or more traffic parameters. For example, the one or more packets may be associated with a source IP address, a source port, a destination IP address, a destination port, and a transport protocol. The source IP address may be the source IP address of the first PDU session 514. For example, the APP/HLOS 506 may be unaware of the second PDU session 520. Therefore, the App/HLOS 506 may indicate that the one or more packets are to be communicated (e.g., sent or transmitted) via the first PDU session 514.

As shown by reference number 530, the UE 120 (e.g., the processing system 508) may determine whether the one or more traffic parameters match one or more filters (e.g., one or more uplink filters). For example, the one or more uplink filters may indicate one or more traffic parameters that are indicative of a traffic type to be communicated via the second PDU session 520 and/or the second network slice. The UE 120 may determine whether the one or more traffic parameters of the one or more packets match (e.g., are the same as or are included in a range indicated by) the one or more traffic parameters indicated by the one or more filters (e.g., one or more uplink filters). If the UE 120 determines that the one or more traffic parameters (e.g., of the packet(s)) do not match the one or more filters, then the UE 120 (e.g., the processing system 508) may transmit or send the data (e.g., the one or more packets) via the first PDU session 514 and/or the first network slice.

Alternatively, if the UE 120 determines that the one or more traffic parameters match the one or more filters, then the UE 120 (e.g., the processing system 508) may transmit or send the data (e.g., the one or more packets) via the second PDU session 520 and/or the second network slice. For example, as shown by reference number 532, the UE 120 (e.g., the processing system 508) may modify the source IP address of the data (e.g., of the one or more packets). For example, the one or more packets obtained by the processing system 508 from the App/HLOS 506 may indicate a first source IP address associated with the first PDU session 514. The UE 120 may modify (e.g., translate) the first source IP address to a second source IP address associated with the second PDU session 520. For example, the UE 120 may modify an IP header of the one or more packets to indicate the second source IP address associated with the second PDU session 520 (e.g., based at least in part on the one or more traffic parameters matching the one or more filters).

As shown by reference number 534, the UE 120 may transmit or send the one or more packets (e.g., with the modified IP header indicating the source IP address of the second PDU session 520) via the second PDU session 520. The one or more network entities 502 may obtain or receive the one or more packets via the second PDU session 520. For example, the UE 120 and the one or more network entities 502 may apply one or more QoS parameters configured for a radio bearer of the second PDU session 520 (e.g., for an air interface transmission that indicates the one or more packets). The one or more network entities 502 may send the one or more packets to the application server 504 (e.g., via a data network, such as the Internet).

As shown in FIG. 5C, and by reference number 536, the application server 504 may send, and the one or more network entities 502 may obtain, data (e.g., one or more packets) for an application executing on the UE 120. The one or more network entities 502 may determine that the data should be communicated via the second PDU session 520 based at least in part on the data being for the application executing on the UE 120. For example, because the UE 120 transmits or sends uplink data from the application via the second PDU session 520 and/or the second network slice (e.g., as described in connection with FIG. 5B and reference number 534), the one or more network entities 504 may determine that downlink data for the application should also be communicated via the second PDU session 520 and/or the second network slice.

The UE 120 may receive the data (e.g., one or more downlink packets) via the second PDU session 520 and/or the second network slice. The one or more downlink packets may indicate an address (e.g., a destination IP address) associated with the second PDU session 520. For example, an IP header of the one or more downlink packets may include the destination IP address of the second PDU session 520.

As shown by reference number 538, the UE 120 (e.g., the processing system 508) may determine whether one or more traffic parameters of the one or more downlink packets match one or more filters (e.g., one or more downlink filters). For example, the one or more downlink filters may indicate one or more traffic parameters that are indicative of a traffic type to be communicated via the second PDU session 520 and/or the second network slice. The UE 120 may determine whether the one or more traffic parameters of the one or more downlink packets match (e.g., are the same as or are included in a range indicated by) the one or more traffic parameters indicated by the one or more filters (e.g., one or more downlink filters). If the UE 120 determines that the one or more traffic parameters (e.g., of the packet(s)) do not match the one or more filters, then the UE 120 (e.g., the processing system 508) may send the data (e.g., the one or more downlink packets) to the App/HLOS 506 without modification.

Alternatively, if the UE 120 determines that the one or more traffic parameters match the one or more downlink filters, then the UE 120 (e.g., the processing system 508) may modify the one or more downlink packets prior to sending the one or more downlink packets to the App/HLOS 506. For example, as shown by reference number 540, the UE 120 (e.g., the processing system 508) may modify the destination IP address of the data (e.g., of the one or more downlink packets). For example, the one or more downlink packets obtained by the processing system 508 from the one or more network entities 502 may indicate a first destination IP address associated with the second PDU session 520. The UE 120 may modify (e.g., translate) the first destination IP address to a second destination IP address associated with the first PDU session 514. For example, the UE 120 may modify an IP header of the one or more downlink packets to indicate the second destination IP address associated with the first PDU session 514 (e.g., based at least in part on the one or more traffic parameters matching the one or more filters). This enables the processing system 508 to send the one or more downlink packets with the destination IP address that is expected by the App/HLOS 506. This enables the App/HLOS 506 to correctly process the one or more downlink packets while still enabling the UE 120 to communicate the one or more downlink packets via the data network using the second network slice. For example, as shown by reference number 542, the processing system 508 may send, and the App/HLOS 506 may obtain, the data (e.g., the one or more downlink packet) with the destination IP address of the first PDU session 514.

As indicated above, FIGS. 5A-5C are provided as examples. Other examples may differ from what is described with respect to FIGS. 5A-5C.

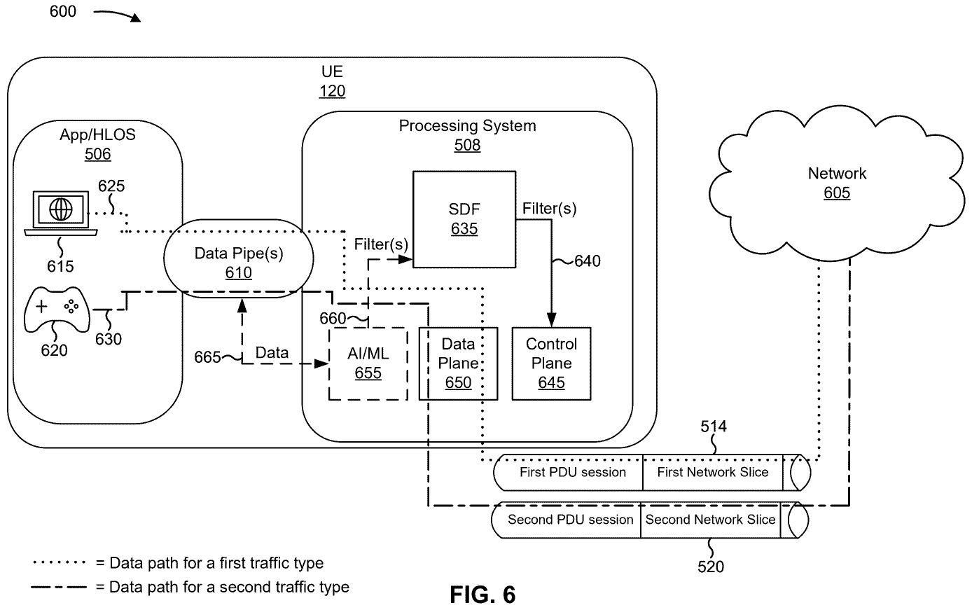

FIG. 6 is a diagram illustrating an example 600 associated with filtering for network slices, in accordance with the present disclosure. As shown in FIG. 6, example 600 includes communication between a UE (e.g., the UE 120) and a network 605. The network 605 may include a wireless communication network (e.g., the wireless communication network 100), a core network, and/or a data network. As shown in FIG. 6, the UE may include the App/HLOS 506 and the processing system 508, as described in connection with FIGS. 5A-5C.

As shown in FIG. 6, there may be one or more data pipes 610 between the App/HLOS 506 and the processing system 508. A data pipe 610 may be an interface for sending and/or obtaining data between the App/HLOS 506 and the processing system 508. A data pipe 610 may include a software interface and/or a hardware interface to enable the communication of data (e.g., packets or frames, depending on the protocol used) between the App/HLOS 506 and the processing system 508. For example, application data may be sent by the App/HLOS 506 to the processing system 508 via a data pipe 610. Data obtained from the network 605 (e.g., after being processed through a physical layer) may be sent by the processing system 508 to the App/HLOS 506 via a data pipe 610.

The App/HLOS 506 may be associated with one or more applications executing on the UE. For example, a first application 615 and a second application 620 may be executing on the UE. The first application 615 may be associated with a first traffic type and the second application 620 may be associated with a second traffic type. As an example, the first application 615 may be associated with Internet browsing traffic (e.g., the first application 615 may be an Internet browser application). The second application 620 may be associated with gaming traffic (e.g., the second application 620 may be a gaming application). As shown in FIG. 6, the first application 615 may be associated with a first data path 625 for traffic (e.g., data and/or packets) associated with the first application 615. The second application 620 may be associated with a second data path 630 for traffic (e.g., data and/or packets) associated with the second application 620. For example, the first data path 625 may include a first network slice (e.g., a default network slice), such as the first network slice associated with the first PDU session 514 described in connection with FIGS. 5A-5C. The second data path 630 may include a second network slice (e.g., a special network slice), such as the second network slice associated with the second PDU session 520 described in connection with FIGS. 5A-5C. For example, a network operator of the network 605 may configure the second traffic type (e.g., gaming traffic) of the second application 620 to be routed via the second network slice (e.g., a special network slice).

As described in more detail elsewhere herein (such as in connection with FIGS. 5A-5C), the UE may route the second traffic type (e.g., gaming traffic) of the second application 620 to the second network slice using one or more filters. For example, the UE may include an SDF component 635. As shown by reference number 640, the SDF component 635 may configure one or more filters via a control plane 645 of the processing system 508. This may cause the one or more filters to be installed in a data plane 650 of the processing system 508. As described in more detail elsewhere herein, the one or more filters may enable the processing system 508 to detect data (e.g., one or more packets) that are associated with the second traffic type (e.g., gaming traffic in the example described above) that is to be routed to the second network slice.

In some aspects, the processing system 508 (e.g., the SDF component 635) may determine the one or more filters based at least in part on information obtained from the App/HLOS 506. For example, the App/HLOS 506 may send, and the processing system 508 may obtain, information regarding one or more applications (e.g., the first application 615 and the second application 620) that are executing on the UE. For example, the information may include traffic parameters (e.g., IP flows) of respective applications. The processing system 508 may determine that the second application 620 is associated with the second traffic type. Therefore, the processing system 508 may configure a filter to enable the processing system 508 to detect data from the second application 620 and determine that the data is associated with the second traffic type.

Additionally, or alternatively, the processing system 508 (e.g., the SDF component 635) may determine the one or more filters based at least in part on an output from an AI/ML component 655 of the UE. The AI/ML component 655 may be, or may include, the model inference host 304. Although the AI/ML component 655 is shown as being included in the processing system 508 as an example, in other examples the AI/ML component 655 may be separate from, or remote from, the processing system 508 (such as in a device 165). The AI/ML component 655 may be configured to output one or more filters (or information that enables the processing system 508 to determine the one or more filters), as shown by reference number 660. For example, as shown by reference number 665, data sent by the App/HLOS 506 may be input to the AI/ML component 655 (e.g., as a machine learning input). In some aspects, one or more traffic types (e.g., the second traffic type) to be communicated over the second network slice may be provided as an input to the AI/ML component 655 (e.g., as a machine learning input). The AI/ML component 655 may be configured to determine, generate, predict, and/or infer, among other examples, one or more filters that enable detection or identification of data (e.g., one or more packets) belonging to the one or more traffic types (e.g., the second traffic type). As shown by reference number 660, the AI/ML component 655 may output, and the processing system 508 (e.g., the SDF component 635) may obtain, information indicative of the one or more filters. This enables the processing system 508 (e.g., the SDF component 635) to configure and/or install the one or more filters on the data plane 650 of the processing system 508.

The App/HLOS 506 may not obtain information indicating that the second network slice and/or the second PDU session 520 has been established. Therefore, the App/HLOS 506 may send data for the second application 620 via the data path 630 with an IP address (e.g., a source IP address) of the first PDU session 514. The processing system 508 may obtain the data (e.g., with the source IP address of the first PDU session 514) via a data pipe 610. As described in more detail elsewhere herein (such as in connection with FIGS. 5A-5C), the processing system 508 may determine that the data (e.g., the one or more packets) matches at least one filter (e.g., an uplink filter). This may indicate that the data is associated with the second traffic type. Therefore, while the data is in the data plane 650 of the processing system 508, the processing system 508 may modify (e.g., translate) the source IP address of the data from the source IP address of the first PDU session 514 to the source IP address of the second PDU session 520. This may cause the data to be transmitted or sent by the UE to the network 605 via the second PDU session 520 and the second network slice.

In some aspects, the network 605 may send data for the second application 620 via the second PDU session 520 and the second network slice. The UE (e.g., the processing system 508) may obtain the data via the second PDU session 520 and the second network slice. The data (e.g., downlink data) may have an IP address (e.g., a destination IP address) of the second PDU session 520. As described in more detail elsewhere herein (such as in connection with FIGS. 5A-5C), the processing system 508 may determine that the data (e.g., downlink data) matches at least one filter (e.g., a downlink filter). This may indicate that the data is associated with the second traffic type. Therefore, while the data is in the data plane 650 of the processing system 508, the processing system 508 may modify (e.g., translate) the destination IP address of the data from the destination IP address of the second PDU session 520 to the destination IP address of the first PDU session 514. The processing system 508 may send, and the App/HLOS 506 may obtain, the data (e.g., via a data pipe 610) having the destination IP address of the first PDU session 514. This enables the App/HLOS 506 to process the data and provide the data to the second application 620. For example, the App/HLOS 506 may expect data for the second application 620 to have a destination IP address of the first PDU session 514 (e.g., because the App/HLOS 506 is unaware of the second PDU session 520). Therefore, without the translation of the destination IP address, the App/HLOS 506 may experience one or more errors when processing the data.

As indicated above, FIG. 6 is provided as an example. Other examples may differ from what is described with respect to FIG. 6.

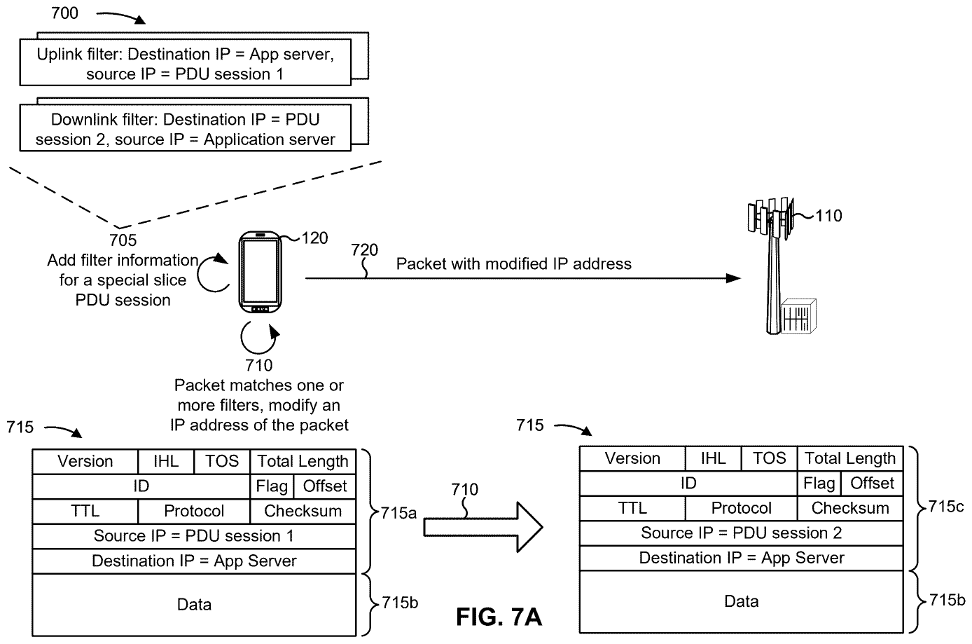

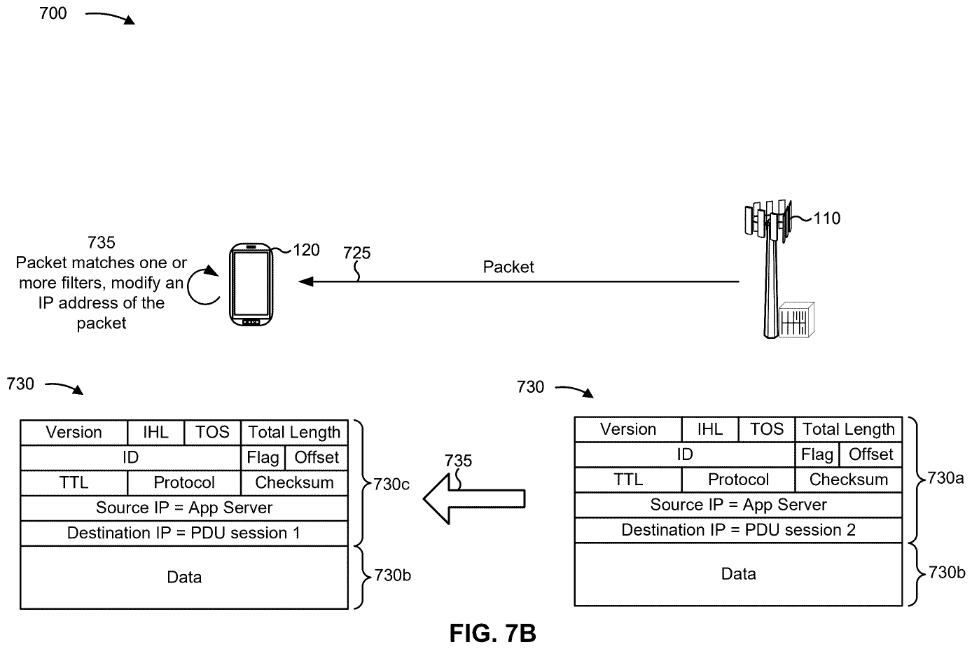

FIGS. 7A-7B are diagrams illustrating an example 700 associated with filtering for network slices, in accordance with the present disclosure. As shown in FIGS. 7A-7B, a UE 120 may communicate with a network node 110. The UE 120 and the network node 110 may be part of a wireless communication network, such as the wireless communication network 100. The network node 110 may be an example of a network entity 502.

As shown in FIG. 7A, and by reference number 705, the UE 120 may add filter information for a special slice PDU session. A special slice PDU session refers to a PDU session associated with a network slice that is configured for a given traffic type. For example, the special slice PDU session may be the second PDU session 520. The UE 120 may autonomously add the filter information for the special slice PDU session.

The UE 120 may obtain filter information for the special slice PDU session. The filter information may include one or more filters to be used to identify traffic (e.g., data and/or packets) that is associated with a traffic type to be communicated by the UE 120 via the special slice PDU session. The filter information may include one or more filters. The one or more filters may include one or more traffic flow template filters. In some aspects, the one or more filters are configured for detection or identification of the one or more traffic types to be communicated by the UE 120 via the special slice PDU session. In some aspects, the one or more filters may include one or more uplink filters (e.g., configured for detection or identification of uplink data associated with the one or more traffic types) and/or one or more downlink traffic types (e.g., configured for detection or identification of downlink data associated with the one or more traffic types). In some aspects, the UE 120 may determine the filter information. Additionally, or alternatively, the UE 120 may obtain the filter information using one or more machine learning techniques.

As shown in FIG. 7A, an uplink filter may indicate a destination IP address of “App Server” which identifies an application server, and a source IP address of “PDU session 1” which identifies a default PDU session, such as the PDU session 514. The uplink filter may indicate other information, such as a transport protocol, an application identifier, a source port, a destination port, or another TFT parameter. A downlink filter may indicate a destination IP address of “PDU session 2” which identifies the special slice PDU session, and a source IP address of “App server” which identifies the application server. The uplink filter may indicate other information, such as a transport protocol, an application identifier, a source port, a destination port, or another TFT parameter.

As shown by reference number 710, the UE 120 may determine that a packet 715 matches one or more filters indicated by the filter information. For example, the UE 120 may determine that the packet 715 matches an uplink filter. As shown in FIG. 7A, the packet 715 may include a header 715a and data 715b. The header 715a may indicate or include one or more traffic parameters of the packet 715. The one or more traffic parameters may include a source IP address, a destination IP address, a transport protocol, a version, an identifier, a source port, and/or a destination port, among other examples. As shown in FIG. 7A, the source IP address of the packet 715 may be “PDU session 1” and the destination IP address of the packet 715 may be “App server.” The UE 120 may obtain the packet 715 via an HLOS of the UE 120.

The UE 120 may determine whether the one or more traffic parameters match one or more filters (e.g., an uplink filter). For example, the one or more uplink filters may indicate one or more traffic parameters that are indicative of a traffic type to be communicated via the special slice PDU session. The UE 120 may determine whether the one or more traffic parameters of the one or more packets match (e.g., are the same as or are included in a range indicated by) the one or more traffic parameters indicated by the one or more filters (e.g., one or more uplink filters). The UE 120 may determine that the one or more traffic parameters match the one or more filters. For example, as shown in FIG. 7A, the source IP address, the destination IP address, and/or other traffic parameters indicated by the header 715a may be the same as indicated by the uplink filter.

The UE 120 may transmit or send the packet 715 via the special slice PDU session. To accomplish this, the UE 120 may modify the source IP address of the packet 715. For example, the UE 120 may modify (e.g., translate) the source IP address to a modified source IP address associated with the special slice PDU session (shown as “PDU session 2” in a modified header 715c of the packet 715. For example, the UE 120 may modify the header 715a of the packet 715 to the modified header 715c that includes the source IP address of the special slice PDU session (e.g., based at least in part on the one or more traffic parameters matching the one or more filters).

As shown by reference number 720, the UE 120 may transmit or send, and the network node 110 may receive or obtain, the packet 715 with the modified IP address. For example, the packet 715 obtained by the network node 110 may include the modified header 715c.

As shown in FIG. 7B, and by reference number 725, the network node 110 may transmit or send, and the UE 120 may receive or obtain, a packet 730. The packet 730 may include a header 730a and data 730b. The header 730a may indicate or include one or more traffic parameters of the packet 730, in a similar manner as the header 715a. For example, the header 730a may indicate a source IP address of “App server” and a destination IP address of “PDU session 2,” among other examples. The UE 120 may determine that the one or more traffic parameters indicated by, or included in, the header 730a match a downlink filter. For example, as shown in FIG. 7B, the source IP address, the destination IP address, and/or other traffic parameters indicated by the header 715a may be the same as indicated by the downlink filter.

Therefore, the UE 120 may modify an IP address of the packet 730. For example, the UE 120 may modify (e.g., translate) the destination IP address to a modified destination IP address associated with the default PDU session (shown as “PDU session 1” in a modified header 730c of the packet 730. For example, the UE 120 may modify the header 730a of the packet 730 to the modified header 730c that includes the destination IP address of the default PDU session (e.g., based at least in part on the one or more traffic parameters matching the one or more filters). This enables other components of the UE 120 (e.g., an HLOS of the UE 120 and/or an application executing on the UE 120) to correctly process the packet 730 because the other components may not be aware of the special slice PDU session. For example, the UE 120 may provide the packet 730 with the modified header 730c to a component of the UE 120, such as an HLOS.

As indicated above, FIGS. 7A-7B are provided as examples. Other examples may differ from what is described with respect to FIGS. 7A-7B.

Network slicing has been specified in 5G. The take off has been limited because of 3 main reasons: 1) HLOS vendors want to be the gatekeepers who decide which app gets preferred slice. Their (e.g., the HLOS vendors) implementations on the operating system (OS) are built this way; 2) Lack of coordination/cooperation between app vendors, HLOS vendors, core network vendors, radio network vendors and operators; 3) The call flows specified in 3GPP are overly complex with many different nodes even within the core network. An external applications server has to interface and interact with the AF to setup slices. Similarly, within the UE, various layers owned by different entities modem, HLOS vendors, the app vendor have to interact.

To bypass all the above hurdles, a UE and/or network operator may implement a simplified, proprietary form of slicing, so that certain types of traffic get the special slice treatment and thus improve user experience.

At the core network: Instead of the complicated call flow between various entities specified in 3gpp as mentioned in previous slide, when a PDU session request for the PDN comes from the UE, the core network knows to expect a second PDU session with a special slice request to also come from the UE. It (e.g., the core network) just accepts it (e.g., the special slice request).

At the RAN: The RAN in turn sets up two radio bearers with the UE not just the usual default data radio bearer for the default PDU session. The default radio bearer with default QoS characteristics and another radio bearer for the special slice PDU session with enhanced QoS for whichever class of application types the operator is most interested in enhancing user experience. For example, operator A maybe interested in giving users better experience for low-latency applications like gaming, so they (e.g., operator A) will configure their special slice with QoS characteristics for low-latency. Operator B maybe interested in giving users better experience for streaming video, so they (e.g., operator B) will configure their special slice with QoS characteristics suitable for streaming video. This can also be extended to multiple simultaneous special slices if operator wants more than one traffic type to get different enhanced QoS characteristics.

At the UE: On powerup, the UE looks at its configuration and knows it (e.g., the UE) has to do proprietary slicing instead of standard 3GPP slicing while in this operator's network. When it (e.g., the UE) does PDU session establishment for a specific PDU it (e.g., the UE) knows to setup second special slice PDU session. UE will autonomously install filters with what it learns using the ML model running on UE. The ML model detects the IP flows (5-tuples) belonging to a certain type of applications for e.g.,: audio/video or gaming or streaming (in an alternative embodiment, instead of ML model, it can be non-ML deterministic info it receives from HLOS about apps running). Which type of applications are of interest can be pre-configured on the UE or downloaded dynamically using normal operations and management (OAM) procedures. There is an element of trust the operator places on UE that it (e.g., the UE) will ensure only filters that match the application traffic types the operator is interested in (as determined by the UE's own ML/non-ML detection) will be installed.

On the uplink: Once the filters are setup on the UE as mentioned in previous slide, when traffic starts flowing and the filter criteria is met, that traffic is put on the special slice and consequently gets enhanced QoS treatment on the radio link as well as in the core network. The UE takes up the responsibility that only the traffic matching these filters (determined by its own ML/non-ML detection of app types) will be sent over the special slice. The UE has to do a translation of the IP addresses from the normal internet PDU session's source (UE) IP address to the special slice source (UE) IP address.

On the downlink: Nothing special to be done by the network. Since the application server and client on UE exchange data, the data is routed to the correct PDU sessions. On the UE, when data comes on the special slice, a translation is done to convert the destination IP address from that of the special slice on UE to the regular PDU session's IP address, so the end client application only sees the regular PDU session's IP address.

Example aspects or steps: 1) ML Based as well as additional logic based identification of the downlink Flows which are of importance (Identifying the Gaming flows vs Regular flows) from Default bearer or Slice. 2) ML Based as well as additional logic based identification of the uplink Flows which are of importance (Identifying the Gaming flows from all the flows) going on Default bearer or Slice. 3) Identified flows are informed to SDF module, to make the control path decision based on the type of configuration (Radio) and licensing information (customer oriented) and deciding the set of flows to be prioritized. 4) SDF informing the set of flows to IP accelerator (IPA) and/or Layer 2(L2 ) to prioritize in downlink path as well as uplink path. In uplink, those set of identified flows are mapped to new bearer (dedicated configured by network but not used) or new slice (configured by network but not used). Based on the flows coming in uplink dedicated bearer or uplink dedicated slice, network will map those flows in reverse in the downlink direction to new dedicated bearer or downlink Slice. 5) Internal to Modem-In uplink, these flows get specialized treatment to go early over-the-air (OTA). In downlink, these flows get specialized treatment from latency/delivery perspective (either in IPA or DL PDCP or both).

With the steps 1-4, Slicing is more coordinated between UE based intelligence to identify the set of flows and informing Radio network to use that in reverse direction (downlink) without coordinating with Applications or end-to-end (E2E) aspects. This is the short form which is appealing to Operators due to bureaucracy in realizing slicing feature with too many stakeholders and Core Network entities dependency/upgrade. Operator to provide special slice treatment to real-time OTT or gaming apps to improve user experience. Time to market the feature without pending on non-3GPP entities.

Example Aspects: Example 1) An apparatus of UE comprising an applications processor (AP) and a cellular modem, with methods on the cellular modem: To setup a special slice PDU session OTA with the network (NW) in addition to the default internet PDU session; To detect and differentiate uplink traffic on the default interface of the applications processor that should get default slice treatment versus special slice treatment; To Transfer the traffic that requires special slice treatment from the default internet PDU session to the special slice PDU session with appropriate translation, QoS and priority over regular default traffic before transmitting on the UL OTA to the NW; To Receive traffic on the downlink OTA from the NW over the special slice PDU session; and/or To Transfer the traffic from the special slice PDU session to the default internet PDU session's default interface with the AP and give it appropriate translation, QoS and priority over regular default traffic. Example 2: with Modem doing all of it without the HLOS or applications being aware of the special slice. Example 3: with Modem generating a rule in local URSP to account for the appropriate traffic. Example 4: where ML techniques are used on the UE to detect the traffic. Example 5: where non-ML techniques are used on the UE to detect the traffic.

At the Network: Example 1: A network (NW) comprising core NW nodes and/or radio NW nodes with methods to: Accept a special slice PDU session request from a UE and set it up OTA as well as the links between core and radio NW, in addition to the default internet PDU session; and/or Without Application Function (AF) and external Application server interaction.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with filtering for network slices.

As shown in FIG. 8, in some aspects, process 800 may include sending a first request to establish a first PDU session that is associated with a first network slice (block 810). For example, the UE (e.g., using communication manager 150 and/or transmission component 904, depicted in FIG. 9) may send a first request to establish a first PDU session that is associated with a first network slice, as described above.

As further shown in FIG. 8, in some aspects, process 800 may include sending a second request to establish a second PDU session that is associated with a second network slice (block 820). For example, the UE (e.g., using communication manager 150 and/or transmission component 904, depicted in FIG. 9) may send a second request to establish a second PDU session that is associated with a second network slice, as described above.

As further shown in FIG. 8, in some aspects, process 800 may include obtaining a packet that indicates a first IP address associated with the first PDU session (block 830). For example, the UE (e.g., using communication manager 150 and/or reception component 902, depicted in FIG. 9) may obtain a packet that indicates a first IP address associated with the first PDU session, as described above.

As further shown in FIG. 8, in some aspects, process 800 may include sending the packet with a second IP address that is associated with the second PDU session based at least in part on a match between one or more traffic parameters of the packet and one or more filters (block 840). For example, the UE (e.g., using communication manager 150 and/or transmission component 904, depicted in FIG. 9) may send the packet with a second IP address that is associated with the second PDU session based at least in part on a match between one or more traffic parameters of the packet and one or more filters, as described above.

Process 800 may include additional aspects, such as any single aspect or any combination of aspects described below and/or in connection with one or more other processes described elsewhere herein.

In a first aspect, the packet is an uplink packet, the first IP address is a first source IP address, the second IP address is a second source IP address, and obtaining the packet includes obtaining the uplink packet with the first source IP address, and sending the packet includes sending, to a network node, the uplink packet with the second source IP address.

In a second aspect, alone or in combination with the first aspect, the packet is a downlink packet, the first IP address is a first destination IP address, the second IP address is a second destination IP address, and obtaining the packet includes obtaining, from a network node, the downlink packet with the first destination IP address, and sending the packet includes sending the downlink packet with the second destination IP address.

In a third aspect, alone or in combination with one or more of the first and second aspects, sending the second request to establish the second PDU session includes autonomously sending the second request after the first request based at least in part on a route selection policy of the UE.

In a fourth aspect, alone or in combination with one or more of the first through third aspects, the second PDU session is associated with one or more traffic types, and the one or more filters indicate the one or more traffic types.

In a fifth aspect, alone or in combination with one or more of the first through fourth aspects, process 800 includes obtaining an indication of the one or more traffic types.

In a sixth aspect, alone or in combination with one or more of the first through fifth aspects, the one or more filters include one or more traffic flow template filters.

In a seventh aspect, alone or in combination with one or more of the first through sixth aspects, process 800 includes sending a machine learning input that includes traffic flow information for previously communicated traffic, and obtaining a machine learning output that indicates the one or more filters.

In an eighth aspect, alone or in combination with one or more of the first through seventh aspects, the machine learning input indicates one or more traffic types associated with the second PDU session, and the one or more filters includes one or more IP flows associated with the one or more traffic types.

In a ninth aspect, alone or in combination with one or more of the first through eighth aspects, process 800 includes obtaining the one or more filters.

In a tenth aspect, alone or in combination with one or more of the first through ninth aspects, process 800 includes modifying, for the packet, the first IP address to the second IP address based at least in part on the match between the one or more traffic parameters of the packet and the one or more filters.

In an eleventh aspect, alone or in combination with one or more of the first through tenth aspects, the one or more filters include one or more first filters for uplink packets and one or more second filters for downlink packets.

In a twelfth aspect, alone or in combination with one or more of the first through eleventh aspects, the first network slice is associated with one or more first QoS parameters, and the second network slice is associated with one or more second QoS parameters.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110 or core network entity 170) performs operations associated with filtering for network slices.

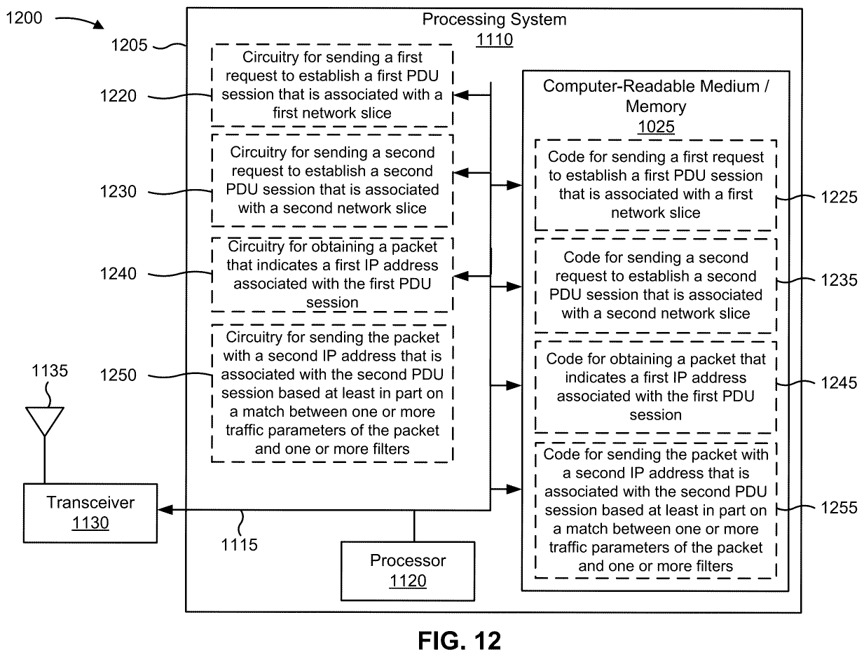

As shown in FIG. 9, in some aspects, process 900 may include obtaining a first request to establish a first PDU session that is associated with a first network slice (block 910). For example, the network node (e.g., using communication manager 155 and/or reception component 1202, depicted in FIG. 12) may obtain a first request to establish a first PDU session that is associated with a first network slice, as described above.

As further shown in FIG. 9, in some aspects, process 900 may include obtaining a second request to establish a second PDU session that is associated with a second network slice (block 920). For example, the network node (e.g., using communication manager 150 and/or reception component 1202, depicted in FIG. 12) may obtain a second request to establish a second PDU session that is associated with a second network slice, as described above.

As further shown in FIG. 9, in some aspects, process 900 may include sending, for the second PDU session, configuration information that indicates one or more first QoS parameters that are based at least in part on one or more traffic types to be communicated via the second PDU session (block 930). For example, the network node (e.g., using communication manager 150 and/or transmission component 1204, depicted in FIG. 12) may send, for the second PDU session, configuration information that indicates one or more first QoS parameters that are based at least in part on one or more traffic types to be communicated via the second PDU session, as described above.

Process 900 may include additional aspects, such as any single aspect or any combination of aspects described below and/or in connection with one or more other processes described elsewhere herein.

In a first aspect, sending the configuration information includes autonomously send the configuration information after the second request based at least in part on a route selection policy.

In a second aspect, alone or in combination with the first aspect, process 900 includes sending an indication of the one or more traffic types.

In a third aspect, alone or in combination with one or more of the first and second aspects, process 900 includes obtaining an uplink packet via the second PDU session, and sending a downlink packet, that is associated with the uplink packet, via the second PDU session based at least in part on the uplink packet being obtained via the second PDU session.

In a fourth aspect, alone or in combination with one or more of the first through third aspects, the first network slice is associated with one or more second QoS parameters.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, another component of a UE (such as an HLOS), a base station, or another wireless communication device) using the reception component 1002 and the transmission component 1004. As further shown, the apparatus 1000 may include the communication manager 150. The communication manager 150 may include one or more of a filtering component 1008, and/or a modification component 1010, among other examples. The communication manager 150 may be included in, or implemented via, a processing system (for example, the processing system 140 described in connection with FIG. 1) of the UE.

In some aspects, the apparatus 1000 may be configured to perform one or more operations described herein in connection with FIGS. 5A-5C and 6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE 120 described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more components of the UE 120 described above in connection with FIG. 1, such as a radio, one or more RF chains, one or more transceivers, or one or more modems, each of which may in turn be coupled with one or more antennas of the UE 120 of the UE described in connection with FIG. 1. In some aspects, the transmission component 1004 may be co-located with the reception component 1002.

The transmission component 1004 may send a first request to establish a first PDU session that is associated with a first network slice. The transmission component 1004 may send a second request to establish a second PDU session that is associated with a second network slice. The reception component 1002 may obtain a packet that indicates a first IP address associated with the first PDU session. The transmission component 1004 may send the packet with a second IP address that is associated with the second PDU session based at least in part on a match between one or more traffic parameters of the packet and one or more filters.

The reception component 1002 may obtain an indication of the one or more traffic types. The transmission component 1004 may send a machine learning input that includes traffic flow information for previously communicated traffic. The reception component 1002 may obtain a machine learning output that indicates the one or more filters. The reception component 1002 may obtain, from an operating system of the UE, the one or more filters.

The filtering component 1008 may filter data based at least in part on the one or more filters. The modification component 1010 may modify, for the packet, the first IP address to the second IP address based at least in part on the match between the one or more traffic parameters of the packet and the one or more filters.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

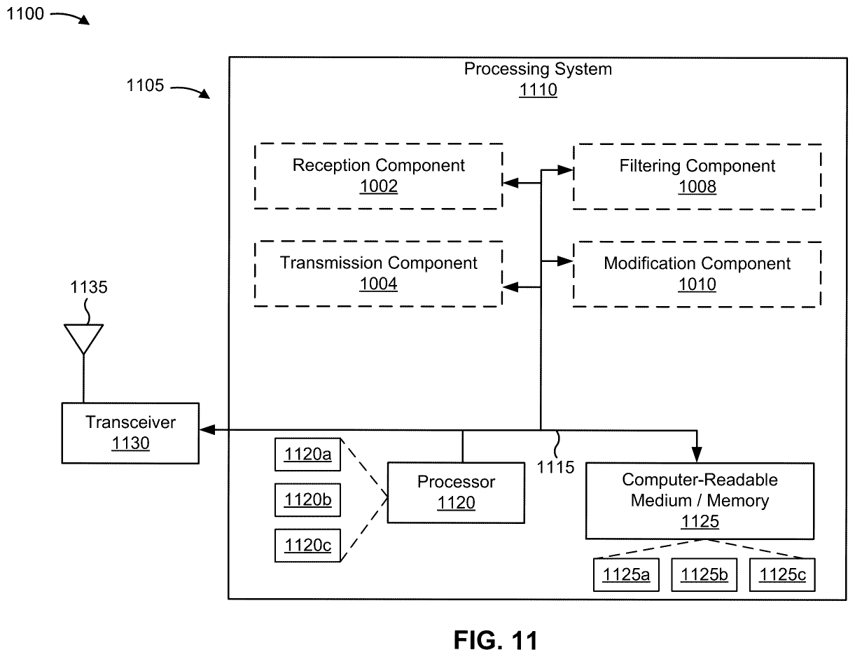

FIG. 11 is a diagram illustrating an example 1100 of a hardware implementation for an apparatus 1105 employing a processing system 1110, in accordance with the present disclosure. The apparatus 1105 may be a UE or may be at (e.g., included in) a UE. The processing system 1110 may be, or may be similar to, the processing system 140.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor (or processing circuitry) 1120, the illustrated components, and the computer-readable medium/memory (or memory circuitry) 1125. The processor 1120 may include multiple processors, such as processor 1120a, processor 1120b, and processor 1120c. The memory 1125 may include multiple memories, such as memory 1125a, memory 1125b, and memory 1125c. The bus 1115 may also link various other circuits, such as timing sources, peripherals, voltage regulators, and/or power management circuits.

The processing system 1110 may be coupled to one or more transceivers 1130. A transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes one or more processors 1120 coupled to a computer-readable medium/memory 1125. A processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and/or may be, may include, or may be included in the processing system 140 of the UE 120 described in connection with FIG. 1. In some aspects, the apparatus 1105 for wireless communication includes means for sending a first request to establish a first PDU session that is associated with a first network slice; means for sending a second request to establish a second PDU session that is associated with a second network slice; means for obtaining a packet that indicates a first IP address associated with the first PDU session; and/or means for sending the packet with a second IP address that is associated with the second PDU session based at least in part on a match between one or more traffic parameters of the packet and one or more filters. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the processing system 140 and/or one or more components of the processing system 140. In one configuration, the aforementioned means may be the processing system 140 and/or one or more components of the processing system 140 configured to perform the functions and/or operations recited herein.

FIG. 11 is provided as an example. Other examples may differ from what is described in connection with FIG. 11.

FIG. 12 is a diagram illustrating an example 1200 of an implementation of code and circuitry for an apparatus 1205, in accordance with the present disclosure. The apparatus 1205 may be a UE, or a UE may include the apparatus 1205.

As shown in FIG. 12, the apparatus 1205 may include circuitry for sending a first request to establish a first PDU session that is associated with a first network slice (circuitry 1220). For example, the circuitry 1220 may enable the apparatus 1205 to send a first request to establish a first PDU session that is associated with a first network slice.

As shown in FIG. 12, the apparatus 1205 may include, stored in computer-readable medium 1125, code for sending a first request to establish a first PDU session that is associated with a first network slice (code 1225). For example, the code 1225, when executed by processor 1120, may cause processor 1120 to cause transceiver 1130 to send a first request to establish a first PDU session that is associated with a first network slice.

As shown in FIG. 12, the apparatus 1205 may include circuitry for sending a second request to establish a second PDU session that is associated with a second network slice (circuitry 1230). For example, the circuitry 1230 may enable the apparatus 1205 to send a second request to establish a second PDU session that is associated with a second network slice.

As shown in FIG. 12, the apparatus 1205 may include, stored in computer-readable medium 1125, code for sending a second request to establish a second PDU session that is associated with a second network slice (code 1235). For example, the code 1235, when executed by processor 1120, may cause processor 1120 to cause transceiver 1130 to send a second request to establish a second PDU session that is associated with a second network slice.

As shown in FIG. 12, the apparatus 1205 may include circuitry for obtaining a packet that indicates a first IP address associated with the first PDU session (circuitry 1240). For example, the circuitry 1240 may enable the apparatus 1205 to obtain a packet that indicates a first IP address associated with the first PDU session.

As shown in FIG. 12, the apparatus 1205 may include, stored in computer-readable medium 1125, code for obtaining a packet that indicates a first IP address associated with the first PDU session (code 1245). For example, the code 1245, when executed by processor 1120, may cause processor 1120 to (e.g., cause transceiver 1130 to) obtain a packet that indicates a first IP address associated with the first PDU session.

As shown in FIG. 12, the apparatus 1205 may include circuitry for sending the packet with a second IP address that is associated with the second PDU session based at least in part on a match between one or more traffic parameters of the packet and one or more filters (circuitry 1250). For example, the circuitry 1250 may enable the apparatus 1205 to send the packet with a second IP address that is associated with the second PDU session based at least in part on a match between one or more traffic parameters of the packet and one or more filters.

As shown in FIG. 12, the apparatus 1205 may include, stored in computer-readable medium 1125, code for sending the packet with a second IP address that is associated with the second PDU session based at least in part on a match between one or more traffic parameters of the packet and one or more filters (code 1255). For example, the code 1255, when executed by processor 1120, may cause processor 1120 to (e.g., cause transceiver 1130 to) send the packet with a second IP address that is associated with the second PDU session based at least in part on a match between one or more traffic parameters of the packet and one or more filters.

FIG. 12 is provided as an example. Other examples may differ from what is described in connection with FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 155. The communication manager 155 may include one or more of a determination component 1308, among other examples. The communication manager 155 may be included in, or implemented via, a processing system (for example, the processing system 145 described in connection with FIG. 1) of the network node.

In some aspects, the apparatus 1300 may be configured to perform one or more operations described herein in connection with FIGS. 5A-5C and 6. Additionally, or alternatively, the apparatus 1300 may be configured to perform one or more processes described herein, such as process 900 of FIG. 9, or a combination thereof. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The reception component 1302 may obtain a first request to establish a first PDU session that is associated with a first network slice. The reception component 1302 may obtain a second request to establish a second PDU session that is associated with a second network slice. The transmission component 1304 may send, for the second PDU session, configuration information that indicates one or more first QoS parameters that are based at least in part on one or more traffic types to be communicated via the second PDU session.

The determination component 1308 may determine to accept the second request based at least in part on a route selection policy that is independent of application input. The transmission component 1304 may send an indication of the one or more traffic types. The reception component 1302 may obtain an uplink packet via the second PDU session. The transmission component 1304 may send a downlink packet, that is associated with the uplink packet, via the second PDU session based at least in part on the uplink packet being obtained via the second PDU session.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

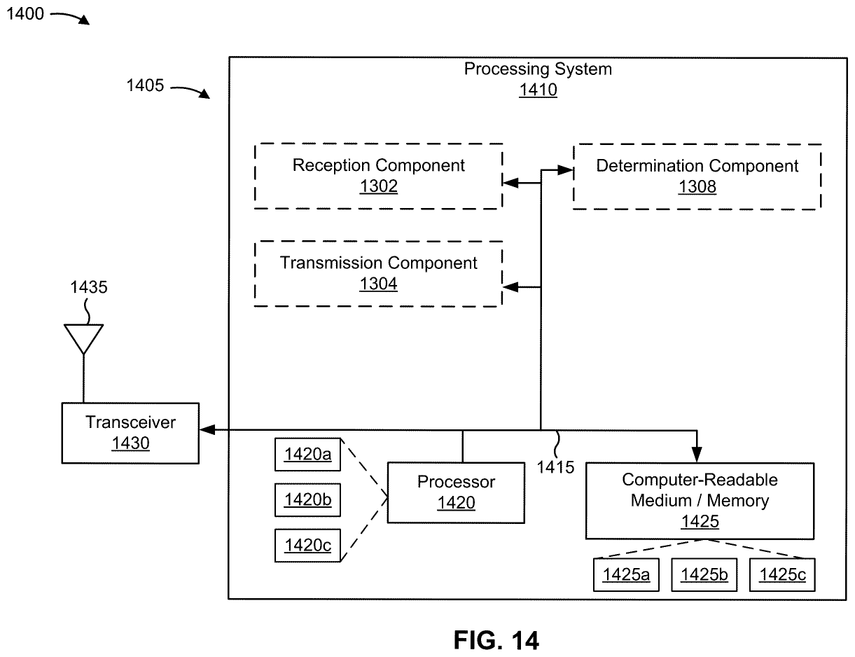

FIG. 14 is a diagram illustrating an example 1400 of a hardware implementation for an apparatus 1405 employing a processing system 1410, in accordance with the present disclosure. The apparatus 1405 may be a network node or may be at (e.g., included in) a network node. The processing system 1410 may be, or may be similar to, the processing system 145 of the network node 110 described in connection with FIG. 1.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor (or processing circuitry) 1420, the illustrated components, and the computer-readable medium/memory (or memory circuitry) 1425. The processor 1420 may include multiple processors, such as processor 1420a, processor 1420b, and processor 1420c. The memory 1425 may include multiple memories, such as memory 1425a, memory 1425b, and memory 1425c The bus 1415 may also link various other circuits, such as timing sources, peripherals, voltage regulators, and/or power management circuits.

The processing system 1410 may be coupled to one or more transceivers 1430. A transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes one or more processors 1420 coupled to a computer-readable medium/memory 1425. A processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the network node 110 and/or may be, may include, or may be included in the processing system 145 of the network node 110 described in connection with FIG. 1. In some aspects, the apparatus 1405 for wireless communication includes means for obtaining a first request to establish a first PDU session that is associated with a first network slice; means for obtaining a second request to establish a second PDU session that is associated with a second network slice; and/or means for sending, for the second PDU session, configuration information that indicates one or more first QoS parameters that are based at least in part on one or more traffic types to be communicated via the second PDU session. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include one or more components of the processing system 145. In one configuration, the aforementioned means may be processing system 145 and/or one or more components of the processing system 145 configured to perform the functions and/or operations recited herein.

FIG. 14 is provided as an example. Other examples may differ from what is described in connection with FIG. 14.

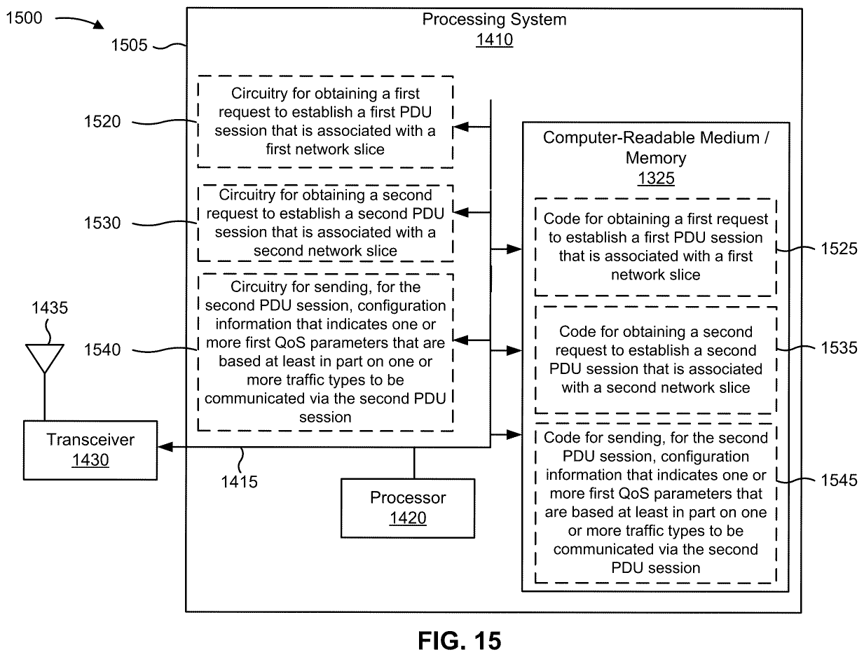

FIG. 15 is a diagram illustrating an example 1500 of an implementation of code and circuitry for an apparatus 1505, in accordance with the present disclosure. The apparatus 1505 may be a network node, or a network node may include the apparatus 1505.

As shown in FIG. 15, the apparatus 1505 may include circuitry for obtaining a first request to establish a first PDU session that is associated with a first network slice (circuitry 1520). For example, the circuitry 1520 may enable the apparatus 1505 to obtain a first request to establish a first PDU session that is associated with a first network slice.

As shown in FIG. 15, the apparatus 1505 may include, stored in computer-readable medium 1425, code for obtaining a first request to establish a first PDU session that is associated with a first network slice (code 1525). For example, the code 1525, when executed by processor 1420, may cause processor 1420 to cause transceiver 1430 to obtain a first request to establish a first PDU session that is associated with a first network slice.

As shown in FIG. 15, the apparatus 1505 may include circuitry for obtaining a second request to establish a second PDU session that is associated with a second network slice (circuitry 1530). For example, the circuitry 1530 may enable the apparatus 1505 to obtain a second request to establish a second PDU session that is associated with a second network slice.

As shown in FIG. 15, the apparatus 1505 may include, stored in computer-readable medium 1425, code for obtaining a second request to establish a second PDU session that is associated with a second network slice (code 1535). For example, the code 1535, when executed by processor 1420, may cause processor 1420 to cause transceiver 1430 to obtain a second request to establish a second PDU session that is associated with a second network slice.

As shown in FIG. 15, the apparatus 1505 may include circuitry for sending, for the second PDU session, configuration information that indicates one or more first QoS parameters that are based at least in part on one or more traffic types to be communicated via the second PDU session (circuitry 1540). For example, the circuitry 1540 may enable the apparatus 1505 to send, for the second PDU session, configuration information that indicates one or more first QoS parameters that are based at least in part on one or more traffic types to be communicated via the second PDU session.

As shown in FIG. 15, the apparatus 1505 may include, stored in computer-readable medium 1425, code for sending, for the second PDU session, configuration information that indicates one or more first QoS parameters that are based at least in part on one or more traffic types to be communicated via the second PDU session (code 1545). For example, the code 1545, when executed by processor 1420, may cause processor 1420 to cause transceiver 1430 to send, for the second PDU session, configuration information that indicates one or more first QoS parameters that are based at least in part on one or more traffic types to be communicated via the second PDU session.

FIG. 15 is provided as an example. Other examples may differ from what is described in connection with FIG. 15.

The following provides an overview of some Aspects of the present disclosure:
Aspect 1: A method of wireless communication performed by a user equipment (UE), comprising: sending a first request to establish a first packet data unit (PDU) session that is associated with a first network slice; sending a second request to establish a second PDU session that is associated with a second network slice; obtaining a packet that indicates a first Internet protocol (IP) address associated with the first PDU session; and sending the packet with a second IP address that is associated with the second PDU session based at least in part on a match between one or more traffic parameters of the packet and one or more filters.
Aspect 2: The method of Aspect 1, wherein the packet is an uplink packet, wherein the first IP address is a first source IP address, wherein the second IP address is a second source IP address, and wherein obtaining the packet comprises: obtaining the uplink packet with the first source IP address, and wherein sending the packet comprises: sending, to a network node, the uplink packet with the second source IP address.
Aspect 3: The method of Aspect 2, wherein the uplink packet is obtained from an operating system of the UE.
Aspect 4: The method of any of Aspects 1-3, wherein the packet is a downlink packet, wherein the first IP address is a first destination IP address, wherein the second IP address is a second destination IP address, and wherein obtaining the packet comprises: obtaining, from a network node, the downlink packet with the first destination IP address, and wherein sending the packet comprises: sending the downlink packet with the second destination IP address.
Aspect 5: The method of Aspect 4, wherein the downlink packet is sent to an operating system of the UE.
Aspect 6: The method of any of Aspects 1-5, wherein sending the second request to establish the second PDU session comprises autonomously sending the second request after the first request based at least in part on a route selection policy of the UE.
Aspect 7: The method of any of Aspects 1-6, wherein the second PDU session is associated with one or more traffic types, and wherein the one or more filters indicate the one or more traffic types.
Aspect 8: The method of Aspect 7, further comprising: obtaining an indication of the one or more traffic types.
Aspect 9: The method of any of Aspects 1-8, wherein the one or more filters include one or more traffic flow template filters.
Aspect 10: The method of any of Aspects 1-9, further comprising: sending a machine learning input that includes traffic flow information for previously communicated traffic; and obtaining a machine learning output that indicates the one or more filters.
Aspect 11: The method of Aspect 10, wherein the machine learning input indicates one or more traffic types associated with the second PDU session, and wherein the one or more filters includes one or more Internet protocol (IP) flows associated with the one or more traffic types.
Aspect 12: The method of any of Aspects 1-11, further comprising: obtaining the one or more filters.
Aspect 13: The method of Aspect 12, wherein the one or more filters are obtained from an operating system of the UE.
Aspect 14: The method of any of Aspects 1-13, further comprising: modifying, for the packet, the first IP address to the second IP address based at least in part on the match between the one or more traffic parameters of the packet and the one or more filters.
Aspect 15: The method of any of Aspects 1-14, wherein the one or more filters include one or more first filters for uplink packets and one or more second filters for downlink packets.
Aspect 16: The method of any of Aspects 1-15, wherein the first network slice is associated with one or more first quality of service (QoS) parameters, and wherein the second network slice is associated with one or more second QoS parameters.
Aspect 17: A method of wireless communication performed by a network node, comprising: obtaining a first request to establish a first packet data unit (PDU) session that is associated with a first network slice; obtaining a second request to establish a second PDU session that is associated with a second network slice; and sending, for the second PDU session, configuration information that indicates one or more first quality of service (QoS) parameters that are based at least in part on one or more traffic types to be communicated via the second PDU session.
Aspect 18: The method of Aspect 17, wherein sending the configuration information comprises autonomously send the configuration information after the second request based at least in part on a route selection policy.
Aspect 19: The method of any of Aspects 17-18, further comprising: sending an indication of the one or more traffic types.
Aspect 20: The method of any of Aspects 17-19, further comprising: obtaining an uplink packet via the second PDU session; and sending a downlink packet, that is associated with the uplink packet, via the second PDU session based at least in part on the uplink packet being obtained via the second PDU session.
Aspect 21: The method of any of Aspects 17-20, wherein the first network slice is associated with one or more second QoS parameters.
Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.
Aspect 23: An apparatus for wireless communication at a device, the apparatus comprising one or more memories and one or more processors coupled to the one or more memories, the one or more processors configured to cause the device to perform the method of one or more of Aspects 1-21.
Aspect 24: An apparatus for wireless communication, the apparatus comprising at least one means for performing the method of one or more of Aspects 1-21.
Aspect 25: A non-transitory computer-readable medium storing code for wireless communication, the code comprising instructions executable by one or more processors to perform the method of one or more of Aspects 1-21.
Aspect 26: A non-transitory computer-readable medium storing a set of instructions for wireless communication, the set of instructions comprising one or more instructions that, when executed by one or more processors of a device, cause the device to perform the method of one or more of Aspects 1-21.
Aspect 27: A device for wireless communication, the device comprising a processing system that includes one or more processors and one or more memories coupled with the one or more processors, the processing system configured to cause the device to perform the method of one or more of Aspects 1-21.
Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.
Aspect 29: An apparatus for wireless communication at a device, comprising: a processing system that includes processor circuitry and memory circuitry that stores code and is coupled with the processor circuitry, the processing system configured to cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “associated with” encompasses any association, connection link, or relation and, therefore, “associated with” may include in associated with, based on, based at least in part on, corresponding to, related to, linked with, connected with, or in response to, among other possibilities. As used herein, “using” may include any use, consideration, calculation, or dependency, among other possibilities. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and configured to cause the UE to:
send a first request to establish a first packet data unit (PDU) session that is associated with a first network slice;
send a second request to establish a second PDU session that is associated with a second network slice;
obtain a packet that indicates a first Internet protocol (IP) address associated with the first PDU session; and
send the packet with a second IP address that is associated with the second PDU session based at least in part on a match between one or more traffic parameters of the packet and one or more filters.

2. The apparatus of claim 1, wherein the packet is an uplink packet, wherein the first IP address is a first source IP address, wherein the second IP address is a second source IP address, and wherein the one or more processors, to obtain the packet, are configured to cause the UE to:
obtain the uplink packet with the first source IP address, and
wherein the one or more processors, to send the packet, are configured to cause the UE to:
send, to a network node, the uplink packet with the second source IP address.

3. The apparatus of claim 1, wherein the packet is a downlink packet, wherein the first IP address is a first destination IP address, wherein the second IP address is a second destination IP address, and wherein the one or more processors, to obtain the packet, are configured to cause the UE to:
obtain, from a network node, the downlink packet with the first destination IP address, and
wherein the one or more processors, to send the packet, are configured to cause the UE to:
send the downlink packet with the second destination IP address.

4. The apparatus of claim 1, wherein the one or more processors, to send the second request to establish the second PDU session, are configured to cause the UE to autonomously send the second request after the first request based at least in part on a route selection policy of the UE.

5. The apparatus of claim 1, wherein the second PDU session is associated with one or more traffic types, and wherein the one or more filters indicate the one or more traffic types.

6. The apparatus of claim 5, wherein the one or more processors are configured to cause the UE to:
obtain an indication of the one or more traffic types.

7. The apparatus of claim 1, wherein the one or more filters include one or more traffic flow template filters.

8. The apparatus of claim 1, wherein the one or more processors are configured to cause the UE to:
send a machine learning input that includes traffic flow information for previously communicated traffic; and
obtain a machine learning output that indicates the one or more filters.

9. The apparatus of claim 8, wherein the machine learning input indicates one or more traffic types associated with the second PDU session, and wherein the one or more filters includes one or more Internet protocol (IP) flows associated with the one or more traffic types.

10. The apparatus of claim 1, wherein the one or more processors are configured to cause the UE to:
obtain the one or more filters.

11. The apparatus of claim 1, wherein the one or more processors are configured to cause the UE to:
modify, for the packet, the first IP address to the second IP address based at least in part on the match between the one or more traffic parameters of the packet and the one or more filters.

12. The apparatus of claim 1, wherein the one or more filters include one or more first filters for uplink packets and one or more second filters for downlink packets.

13. The apparatus of claim 1, wherein the first network slice is associated with one or more first quality of service (QoS) parameters, and wherein the second network slice is associated with one or more second QoS parameters.

14. A method of wireless communication performed at a user equipment (UE), comprising:
sending a first request to establish a first packet data unit (PDU) session that is associated with a first network slice;
sending a second request to establish a second PDU session that is associated with a second network slice;
obtaining a packet that indicates a first Internet protocol (IP) address associated with the first PDU session; and
sending the packet with a second IP address that is associated with the second PDU session based at least in part on a match between one or more traffic parameters of the packet and one or more filters.

15. The method of claim 14, wherein the packet is an uplink packet, wherein the first IP address is a first source IP address, wherein the second IP address is a second source IP address, and wherein obtaining the packet comprises:
obtaining the uplink packet with the first source IP address, and
wherein sending the packet comprises:
sending, to a network node, the uplink packet with the second source IP address.

16. The method of claim 14, wherein the packet is a downlink packet, wherein the first IP address is a first destination IP address, wherein the second IP address is a second destination IP address, and wherein obtaining the packet comprises:
obtaining, from a network node, the downlink packet with the first destination IP address, and
wherein sending the packet comprises:
sending the downlink packet with the second destination IP address.

17. The method of claim 14, wherein the second PDU session is associated with one or more traffic types, and wherein the one or more filters indicate the one or more traffic types.

18. The method of claim 17, further comprising:
obtaining an indication of the one or more traffic types.

19. The method of claim 14, further comprising:
sending a machine learning input that includes traffic flow information for previously communicated traffic; and
obtaining a machine learning output that indicates the one or more filters.

20. A non-transitory computer-readable medium storing a set of instructions for wireless communication, the set of instructions comprising:
one or more instructions that, when executed by one or more processors of a user equipment (UE), cause the UE to:
send a first request to establish a first packet data unit (PDU) session that is associated with a first network slice;
send a second request to establish a second PDU session that is associated with a second network slice;
obtain a packet that indicates a first Internet protocol (IP) address associated with the first PDU session; and
send the packet with a second IP address that is associated with the second PDU session based at least in part on a match between one or more traffic parameters of the packet and one or more filters.
